(19) United States
(12) Patent Application Publication
(10) Pub. No.: US 2018/0293635 A1
(43) Pub. Date: Oct. 11, 2018

(54) SYSTEM, IMAGE RECOGNITION METHOD, AND RECORDING MEDIUM

(71) Applicant: NEC Corporation, Tokyo (JP)

(72) Inventor: Ruihan BAO, Tokyo (JP)

(73) Assignee: NEC Corporation, Tokyo (JP)

(21) Appl. No.: 15/557,844

(22) PCT Filed: Mar. 9, 2016
(86) PCT No.: PCT/JP2016/001291

§ 371 Date: Sep. 13, 2017

(30) Foreign Application Priority Data
Mar. 16, 2015 (JP) 2015-052216

(51) Int. Cl. G06Q 30/06; G06Q 10/08; G06F 17/30; G06K 9/00

(52) U.S. Cl. CPC G06Q 30/0625; G06K 9/00624; G06F 17/30247; G06Q 10/087

(57) ABSTRACT

A system includes: a data determination unit configured to specify checking target data being data of a checking target, from a database storing information about a plurality of products, based on product data related to a product sold at a store; and an image recognition unit configured to recognize, by using an image captured at the store, a recognition target product included in the captured image, from the specified checking target data.

### TECHNICAL FIELD

The present invention relates to an image recognition apparatus, a system, an image recognition method, and a recording medium.

### BACKGROUND ART

A method of recognizing an image captured by a digital camera or the like is described in, for example, PTL 1. An information processing system described in PTL 1 recognizes a captured image by distinguishing whether or not the captured image information matches search image information in a database.

Further, methods of using a co-occurrence probability and the like in recognition are described in PTLs 2 and 3.

### CITATION LIST

### Patent Literature

PTL 1: Japanese Unexamined Patent Application Publication No. 2003-16086

PTL 2: Japanese Unexamined Patent Application Publication No. 2009-265905

PTL 3: Japanese Translation of PCT International Application Publication No. 2009-521665

### SUMMARY OF INVENTION

### Technical Problem

At a store selling products (goods), it is known that sales of the products depend on an arrangement for displaying the products. Accordingly, a method of recognizing the displayed products from a captured image capturing the arrangement state of the products has been developed.

Usually, a database storing information about a plurality of products stores the information about the plurality of products independent of whether the product is currently sold or not at a store. Accordingly, when recognizing a product included in a captured image from the captured image, the product included in the captured image is checked against every product included in the database, and therefore, for example, the product included in the captured image may be recognized to such product similar to the captured product, causing decrease in recognition accuracy.

PTLs 1 to 3 do not mention the problem at all.

The present invention is made in view of the aforementioned problem, and an object thereof is to provide a technology of improving recognition accuracy of a product included in a captured image.

### Solution to Problem

An image recognition apparatus according to one aspect of the present invention includes: data determination means for specifying checking target data being data of a checking target, from a database storing information about a plurality of products, based on product data related to a product sold at a store; and image recognition means for recognizing, by using an image captured at the store, a recognition target product included in the captured image, from the specified checking target data.

A system according to one aspect of the present invention includes: an imaging device that captures an image of a product sold at a store, an image recognition apparatus that receives the image captured by the imaging device, and a database management apparatus that manages a database storing information about a plurality of products, wherein the image recognition apparatus includes data determination means for specifying checking target data being data of a checking target, from the database, based on product data related to a product sold at the store, and image recognition means for recognizing, by using the image received from the imaging device, a recognition target product included in the captured image, from the specified checking target data.

A system according to one aspect of the present invention includes: an imaging device that captures an image of a product sold at a store, an image recognition apparatus that receives the image captured by the imaging device, and a database management apparatus that manages a database storing information about a plurality of products, wherein the database management apparatus includes data determination means for specifying checking target data being data of a checking target, from the database, based on product data related to a product sold at the store, and wherein the image recognition apparatus includes image recognition means for recognizing, by using the image received from the imaging device, a recognition target product included in the captured image, from the specified checking target data.

A system according to one aspect of the present invention includes: an imaging device that captures an image of a product sold at a store, an image recognition apparatus that receives the image captured by the imaging device, and a database management apparatus that manages a database storing information about a plurality of products, wherein the database management apparatus includes first data determination means for specifying checking target data being data of a checking target, from the database, based on product data related to a product sold at the store, and wherein the image recognition apparatus includes image recognition means for recognizing, by using the image received from the imaging device, a recognition target product included in the captured image, from the specified checking target data.

An image recognition apparatus according to one aspect of the present invention includes: image recognition means for recognizing, by using an image captured at a store, a recognition target product included in the captured image, from a database storing information about a plurality of products; calculation means for calculating, based on product data related to a product sold at the store, a proportion of the product to a total number of products within a predetermined range; and correction means for correcting a recognition result with respect to a recognition target product included in the captured image, based on the proportion calculated by the calculation means, wherein the calculation means calculates the proportion in such a way that a recognition score indicating certainty of the recognition result with respect to a product an inventory quantity of which is larger than that of another product is given a value higher than a recognition score with respect to the another product.

An image recognition method according to one aspect of the present invention includes: based on product data related to a product sold at a store, specifying checking target data being data of a checking target, from a database storing information about a plurality of products; and, by using an image captured at the store, recognizing a recognition target product included in the captured image, from the specified checking target data.

A computer program causing a computer to provide each apparatus, system, or method described above, and a computer-readable storage medium storing the computer program also fall under the category of the present invention.

### Advantageous Effects of Invention

The present invention is able to improve recognition accuracy of a product included in a captured image.

### BRIEF DESCRIPTION OF DRAWINGS

FIG. 1 is a diagram illustrating an example of an entire configuration of an image recognition system including an image recognition apparatus according to a first example embodiment of the present invention.

FIG. 2 is a functional block diagram illustrating an example of a functional configuration of the image recognition apparatus according to the first example embodiment of the present invention.

FIG. 3 is a flowchart illustrating an example of a flow of checking target data determination processing in the image recognition apparatus according to the first example embodiment of the present invention.

FIG. 4 is a flowchart illustrating an example of a flow of image recognition processing in the image recognition apparatus according to the first example embodiment of the present invention.

FIG. 5 is a functional block diagram illustrating an example of a functional configuration of an image recognition apparatus according to a second example embodiment of the present invention.

FIG. 6 is a flowchart illustrating an example of a flow of image recognition processing in the image recognition apparatus according to the second example embodiment of the present invention.

FIG. 7 is a functional block diagram illustrating an example of a functional configuration of an image recognition apparatus according to a third example embodiment of the present invention.

FIG. 8 is a flowchart illustrating an example of a flow of prior probability calculation processing in the image recognition apparatus according to the third example embodiment of the present invention.

FIG. 9 is a flowchart illustrating an example of a flow of image recognition processing in the image recognition apparatus according to the third example embodiment of the present invention.

FIG. 10 is a functional block diagram illustrating an example of a functional configuration of an image recognition apparatus according to a fourth example embodiment of the present invention.

FIG. 11 is a flowchart illustrating an example of a flow of image recognition processing in the image recognition apparatus according to the fourth example embodiment of the present invention.

FIG. 12 is a diagram illustrating an example of an entire configuration of an image recognition system including an image recognition apparatus according to a fifth example embodiment of the present invention.

FIG. 13 is a functional block diagram illustrating an example of functional configurations of the image recognition apparatus and a product DB management apparatus, according to the fifth example embodiment of the present invention.

FIG. 14 is a flowchart illustrating an example of a flow of image recognition processing in the image recognition apparatus according to the fifth example embodiment of the present invention.

FIG. 15 is a functional block diagram illustrating an example of functional configurations of an image recognition apparatus and a product DB management apparatus, according to a sixth example embodiment of the present invention.

FIG. 16 is a flowchart illustrating an example of a flow of image recognition processing in the image recognition apparatus according to the sixth example embodiment of the present invention.

FIG. 17 is a functional block diagram illustrating an example of a functional configuration of an image recognition apparatus according to a seventh example embodiment of the present invention.

FIG. 18 is a flowchart illustrating an example of a flow of image recognition processing in the image recognition apparatus according to the seventh example embodiment of the present invention.

FIG. 19 is a functional block diagram illustrating an example of a functional configuration of an image recognition apparatus according to an eighth example embodiment of the present invention.

FIG. 20 is a functional block diagram illustrating an example of a functional configuration of an image recognition system according to a ninth example embodiment of the present invention.

FIG. 21 is a diagram exemplifying a hardware configuration of a computer (information processing apparatus) that is able to provide the respective example embodiments of the present invention.

### EXAMPLE EMBODIMENTS

### First Example Embodiment

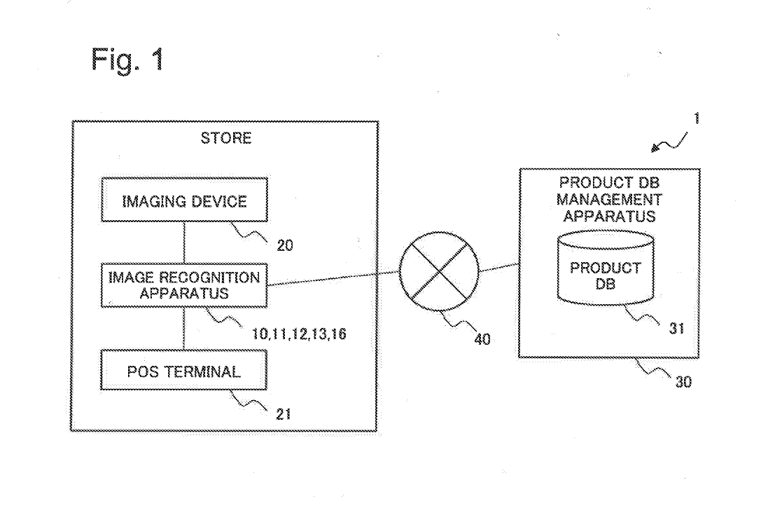

Referring to drawings, a first example embodiment of the present invention will be described in detail. First, referring to FIG. 1, an entire configuration of an image recognition system including an image recognition apparatus according to the present example embodiment will be described.

FIG. 1 is a diagram illustrating an example of an entire configuration of the image recognition system including the image recognition apparatus according to the present example embodiment. As illustrated in FIG. 1, the image recognition system 1 according to the present example embodiment includes an image recognition apparatus 10, an imaging device 20, a point of sale (POS) terminal 21, and a product database (DB) management apparatus 30. The image recognition apparatus 10 and the product DB management apparatus 30 are communicably connected to one another through a network 40. Further, the image recognition apparatus 10 is communicably connected to the imaging device 20 and the POS terminal 21. The image recognition system 1 illustrated in FIG. 1 illustrates a configuration characteristic of the present example embodiment, and it goes without saying that the image recognition system 1 illustrated in FIG. 1 may include a part not illustrated in FIG. 1.

The product DB management apparatus 30 manages a database storing information about a plurality of products. As illustrated in FIG. 1, the product DB management apparatus 30 includes a product DB 31. The product DB 31 is a database storing information about a plurality of products. Specifically, for each product, the product DB 31 stores information about a product, the information being used when the image recognition apparatus 10 recognizes the product. For example, the product DB 31 includes a product image for each product name. Data included in the product DB 31 have only to be information used when a product is recognized, and, for example, may be data indicating a feature point within a product image.

The imaging device 20 is provided by one or more surveillance cameras or the like installed at each of one or more shops or stores. While FIG. 1 illustrates only one store for convenience of description, a number of stores is one or more. Further, the imaging device 20 is not limited to a surveillance camera, and may be a portable device possessed by a user, or another imaging device.

The imaging device 20 captures an image of a product arranged (displayed) at a store. The product is generally displayed on a store shelf (also simply referred to as a shelf) installed at a store. Accordingly, the imaging device 20 may be considered to capture an image of a store shelf on which the products are displayed. Then, the imaging device 20 transmits captured image data (also simply referred to as image data) representing a captured image in which the product is included to the image recognition apparatus 10.

The image recognition apparatus 10 communicates with one or more POS terminals 21 installed at a store where the image recognition apparatus 10 is installed, and receives product data being information about products sold at the store from the POS terminals 21. For example, the image recognition apparatus 10 receives information about sales of each product (sales information) as product data. For example, it is assumed that the sales information is common POS data such as a sales figure and a sales volume of a certain product, but the sales information is not limited thereto. Further, for example, the image recognition apparatus 10 may receive information about purchase a stock of a product (purchase information), information about ordering of a product (ordering information) and the like as product data. The product data include information identifying each product. While a product name is cited and described as an example of information identifying each product, according to the present example embodiment, the information identifying each product is not limited thereto, and may be, for example, a product identifier (ID). Further, for example, for each product, the product data may include information about a type (category) and the like of the product.

Further, the image recognition apparatus 10 may acquire product data from another apparatus other than the POS terminal 21. For example, when an apparatus to which a user inputs ordering information and order receipt information is an apparatus other than the POS terminal 21, the image recognition apparatus 10 may receive product data from the apparatus to which ordering information and order receipt information are input.

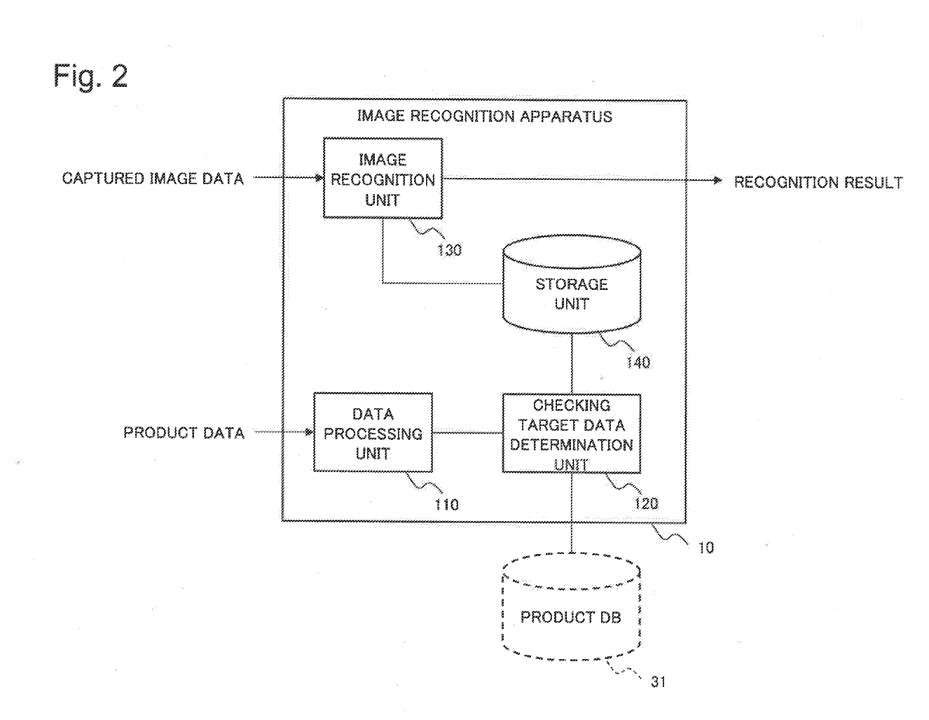

Further, the image recognition apparatus 10 receives captured image data from one or more imaging devices 20 installed at a store where the image recognition apparatus 10 is installed. A detailed function of the image recognition apparatus 10 will be described referring to FIG. 2.

### Functional Configuration of Image Recognition Apparatus 10

Next, referring to FIG. 2, a functional configuration of the image recognition apparatus 10 according to the present example embodiment will be described. FIG. 2 is a functional block diagram illustrating an example of the functional configuration of the image recognition apparatus 10 according to the present example embodiment.

As illustrated in FIG. 2, the image recognition apparatus 10 according to the present example embodiment includes a data processing unit 110, a checking target data determination unit (data determination unit) 120, an image recognition unit 130, and a storage unit 140.

The data processing unit 110 receives product data from the POS terminal 21 and/or another apparatus. Then, the data processing unit 110 calculates a quantity related to each product sold at the store, based on at least one item of sales information, purchase information, and ordering information, being included in the product data. Specifically, the data processing unit 110 calculates an inventory quantity of each product, based on the product data. The data processing unit 110 may calculate a sales volume (quantity sold), a purchase quantity, an ordering quantity, and the like of each product. Further, for example, when the product data include information indicating an inspected product out of products purchased by the store, the data processing unit 110 may calculate a quantity of each inspected product (quantity inspected). Further, when the product data include information indicating a product displayed in-store, the data processing unit 110 may calculate a quantity of a product displayed in the store for each product. Further, when the product data include information indicating a discarded product, the data processing unit 110 may calculate a quantity of each discarded product (quantity discarded). Further, the data processing unit 110 may calculate a quantity displayed at the time for each product, based on a history of quantities of products displayed at the store, and a sales volume. Thus, the data processing unit 110 may calculate a quantity related to each product, based on a history of sales, purchase, ordering, inspection, discard, display, and the like of the product.

The data processing unit 110 outputs a calculated quantity of each product sold at the store to the checking target data determination unit 120 along with a product name of each product. Data composed of a product name and a quantity of a product indicated by the product name, the name and the quantity being output by the data processing unit 110, are hereinafter referred to as product quantity information.

The checking target data determination unit 120 receives product quantity information from the data processing unit 110. Then, based on a quantity related to each product, being included in the product quantity information, the checking target data determination unit 120 extracts, from data stored in the product DB 31, data (checking target data) used as a checking target (search target) when the image recognition unit 130 performs image recognition. Specifically, the checking target data determination unit 120 extracts a product an inventory quantity of which is zero in a store where the image recognition apparatus 10 including the checking target data determination unit 120 is installed, out of products included in the product DB 31, and newly generates a database in which the extracted product data are deleted. Then, the checking target data determination unit 120 determines data constituting the newly generated database to be checking target data used as a checking target when the image recognition unit 130 performs image recognition. In other words, the checking target data determination unit 120 extracts data related to a product a product quantity of which is one or more from the product DB 31, and generates a database specified by the extracted data.

When the image recognition unit 130 performs recognition processing by using data related to every product included in the product DB 31, checking target data to be used as data of a checking target become data related to every product in the aforementioned product DB 31. However, as described above, the checking target data determination unit 120 generates a database in which data of a product an inventory quantity of which is zero is deleted. That is to say, the checking target data determination unit 120 is able to specify from the product DB 31 checking target data used by the image recognition unit 130 as data in checking.

A product an inventory quantity of which is zero represents, for example, (a) and (b) described below:
(a) a product a product quantity of which included in product quantity information is zero, and
(b) a product a product name of which is included in the product DB 31 and not included in the product quantity information.

The checking target data determination unit 120 stores the generated database in the storage unit 140. The checking target data determination unit 120 may output the generated database to the image recognition unit 130.

The storage unit 140 stores information representing checking target data specified by the checking target data determination unit 120. Specifically, the storage unit 140 stores a database generated by the checking target data determination unit 120. Data constituting the database stored by the storage unit 140 are checking target data used as a checking target when image recognition is performed, as described above. The storage unit 140 may be included in the image recognition apparatus 10, or may be provided by a storage device separate from the image recognition apparatus 10. The storage unit 140 may be included in the checking target data determination unit 120. Further, when the checking target data determination unit 120 outputs generated checking target data to the image recognition unit 130, the storage unit 140 may be included in the image recognition unit 130.

The image recognition unit 130 receives captured image data from the imaging device 20. A captured image represented by the captured image data is an image being a target of image recognition (referred to as a target image). The image recognition unit 130 performs image recognition of a target image on checking target data in which data of a checking target are specified by the checking target data determination unit 120. Specifically, by checking the target image against the checking target data, the image recognition unit 130 recognizes a product included in the target image. The image recognition unit 130 outputs the result of image recognition (referred to as a recognition result). For example, the image recognition unit 130 may output the result to the storage unit 140 or an unillustrated display device.

### Flow of Processing in Image Recognition Apparatus 10

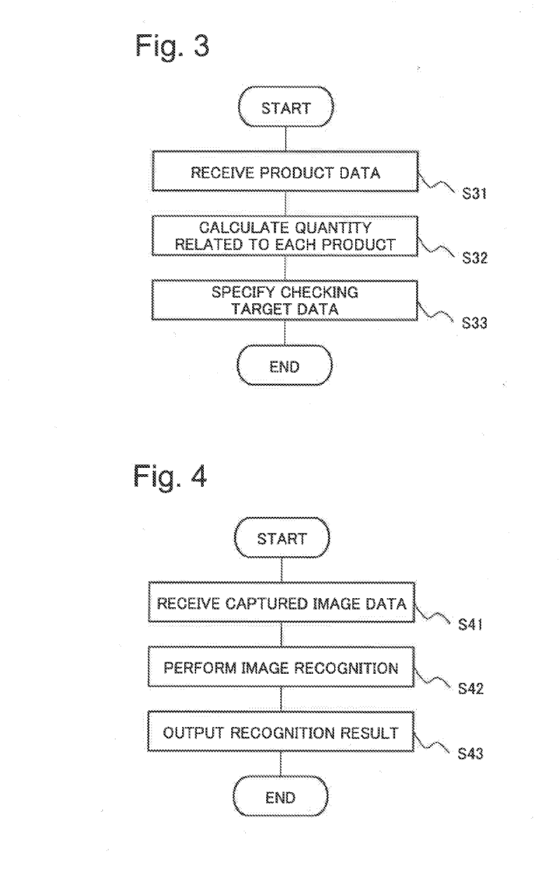

Next, referring to FIGS. 3 and 4, a flow of processing in the image recognition apparatus 10 will be described. FIG. 3 is a flowchart illustrating an example of a flow of checking target data determination processing in the image recognition apparatus 10 according to the present example embodiment.

As described in FIG. 3, first, the data processing unit 110 receives product data from the POS terminal 21 and/or another apparatus (Step S31).

Then, the data processing unit 110 calculates a quantity of each product sold at the store (e.g. a sales volume, a purchase quantity, an ordering quantity, a quantity inspected, and a quantity displayed, for each product), based on the received product data (Step S32).

Subsequently, the checking target data determination unit 120 specifies checking target data in the product DB 31, based on the quantity for each product (Step S33). Specifically, as described above, the checking target data determination unit 120 generates, from the product DB 31, a database composed of checking target data used by the image recognition unit 130 as a checking target when the image recognition unit 130 performs image recognition, based on the quantity related to each product calculated in Step S32.

The above concludes the checking target data determination processing by the image recognition apparatus 10.

Next, referring to FIG. 4, image recognition processing in the image recognition apparatus 10 according to the present example embodiment will be described. FIG. 4 is a flowchart illustrating an example of a flow of the image recognition processing in the image recognition apparatus 10 according to the present example embodiment.

As described in FIG. 4, first, the image recognition unit 130 receives captured image data from the imaging device 20 (Step S41).

Next, by using checking target data specified by the checking target data determination unit 120 in Step S33, the image recognition unit 130 performs image recognition of a captured image represented by the captured image data (Step S42).

Then, the image recognition unit 130 outputs the recognition result (Step S43).

The above concludes the image recognition processing by the image recognition apparatus 10.

The image recognition apparatus 10 may perform the aforementioned checking target data determination processing and the image recognition processing synchronously or asynchronously. For example, the image recognition apparatus 10 may perform the checking target data determination processing immediately before performing the image recognition processing.

Further, for example, the image recognition apparatus 10 may perform the checking target data determination processing at a predetermined time, independent of an execution time of the image recognition processing. For example, the predetermined time is a time when a product is displayed in a store, a time when a product is purchased, or a time when a product is inspected, but is not limited thereto. Further, at this time, the checking target data determination unit 120 may update checking target data used as a checking target. For example, when a product is displayed in a store, and a user notifies the image recognition apparatus 10 of information indicating the displayed product by using an unillustrated input device or the like, the image recognition apparatus 10 checks whether or not the checking target data include the product. Then, when the checking target data do not include the product, the image recognition apparatus 10 includes the aforementioned product in the checking target data.

Further, the image recognition apparatus 10 may perform the checking target data determination processing every time a product is sold. For example, when a product is sold, the image recognition apparatus 10 may check a current inventory quantity of the product, and when the inventory quantity is zero, delete the product from the checking target data. Thus, the checking target data determination unit 120 is able to update the checking target data at a predetermined timing.

### Effect

The image recognition apparatus 10 according to the present example embodiment is able to improve recognition accuracy of a product included in a captured image. The reason is that the checking target data determination unit 120 specifies checking target data from the product DB 31, based on product data, and, by using the specified checking target data, the image recognition unit 130 recognizes a product included in a captured image. At this time, it is preferable that the checking target data determination unit 120 specify the checking target data by generating a database in which a product an inventory quantity of which in a store is zero is deleted from the product DB 31.

Consequently, the image recognition apparatus 10 according to the present example embodiment is able to recognize a recognition target product by checking the checking target data against the recognition target product. A large amount of checking target data to be checked causes a variation in recognition results, and recognition accuracy decreases. However, a quantity of products included in checking target data specified by the image recognition apparatus 10 according to the present example embodiment is less than a quantity of products included in the product DB 31. Accordingly, the image recognition apparatus 10 according to the present example embodiment is able to improve recognition accuracy.

Further, the image recognition apparatus 10 only acquires data in checking target data specified by the checking target data determination unit 120 from the product DB management apparatus 30, and therefore is able to reduce communication traffic between the image recognition apparatus 10 and the product DB management apparatus 30.

Further, the image recognition apparatus 10 does not perform checking against a product an inventory quantity of which is zero, and therefore is able to reduce the time required for recognition processing.

### Modified Example

While the checking target data determination unit 120 according to the aforementioned first example embodiment has been described to newly generate a database composed of checking target data, the checking target data determination unit 120 may not generate a database. In the present modified example, a method of the checking target data determination unit 120 specifying checking target data without generating a database will be described.

The checking target data determination unit 120 according to the present modified example determines data to be used as checking target data from the product DB 31. Then, the checking target data determination unit 120 performs control in such a way that the image recognition unit 130 uses the determined data as checking target data when performing image recognition.

For example, the checking target data determination unit 120 stores a product name associated with data used as checking target data from the product DB 31 into the storage unit 140. Then, the checking target data determination unit 120 performs control in such a way that the image recognition unit 130 uses the product name data stored in the storage unit 140 out of the product DB 31 when performing image recognition.

Further, for example, the checking target data determination unit 120 may generate a flag that indicates 1 for data used in image recognition and a flag indicating 0 for data not used, out of data in the product DB 31. Then, the checking target data determination unit 120 may perform control in such a way that the image recognition unit 130 only uses data with a flag being 1 in image recognition. At this time, the checking target data determination unit 120 may store the generated flag in the storage unit 140 as information indicating the specified checking target data.

Further, for example, the checking target data determination unit 120 may issue a command for generating a view composed of data used as checking target data from a table included in the product DB 31, and control the image recognition unit 130 in such a way to perform image recognition using the view. At this time, the checking target data determination unit 120 may store the issued command in the storage unit 140 as information indicating the specified checking target data. Thus, the checking target data determination unit 120 in the image recognition apparatus 10 according to the present modified example may specify checking target data from the product DB 31 by any method.

The present modified example is able to reduce the time required for a search and improve recognition accuracy, similarly to the image recognition apparatus 10 according to the aforementioned first example embodiment. Further, the checking target data determination unit 120 does not newly generate a database in the image recognition apparatus 10, and therefore a data amount transmitted from the product DB management apparatus 30 to the image recognition apparatus 10 can be reduced.

Further, the checking target data determination unit 120 according to the present modified example may also update checking target data at a predetermined timing. For example, when the checking target data determination unit 120 stores a product name associated with data used as checking target data from the product DB 31 into the storage unit 140, the checking target data determination unit 120 may update the checking target data by updating the product name at a predetermined timing.

Further, for example, when the checking target data determination unit 120 generates a flag with respect to data in the product DB 31, the checking target data determination unit 120 may update checking target data by updating the flag at a predetermined timing.

Thus, the checking target data determination unit 120 according to the present modified example is able to update checking target data at a predetermined timing, similarly to the checking target data determination unit 120 according to the first example embodiment.

### Second Example Embodiment

Next, referring to drawings, a second example embodiment of the present invention will be described. For convenience of description, a same reference sign is given to a part having a same function as a part included in a drawing described in the aforementioned first example embodiment, and description thereof is omitted.

The checking target data determination unit 120 according to the aforementioned first example embodiment has been described to specify checking target data, based on product data in a store where the image recognition apparatus 10 is provided. Additional use of information about a captured shelf as product data will be described in the present example embodiment.

An image recognition system 1 according to the present example embodiment includes an image recognition apparatus 11 in place of the image recognition apparatus 10 in the image recognition system 1 according to the aforementioned first example embodiment. The remaining configuration of the image recognition system 1 according to the present example embodiment is similar to that of the image recognition system 1 according to the aforementioned first example embodiment, as illustrated in FIG. 1.

Captured image data representing an image captured by an imaging device 20, according to the present example embodiment, include information (captured shelf information) indicating which store shelf is captured in the captured image data. While it is assumed that the captured shelf information includes information indicating a store where the imaging device 20 is installed and information indicating a position of the store shelf captured by the imaging device 20, the captured shelf information is not limited thereto. The captured shelf information may be input by a capturer, or may be capturing position information indicating a position of the imaging device 20, the position being measured by using, for example, the Global Positioning System (GPS) or the like. Further, for example, the captured shelf information may be information indicating a position of the imaging device 20 and information indicating a direction of the imaging device 20. Which store shelf is captured by the imaging device 20 can be distinguished by the position of the imaging device 20 and the direction of the imaging device 20. Thus, the captured shelf information has only to be information by which a position of the captured store shelf can be distinguished.

### Functional Configuration of Image Recognition Apparatus 11

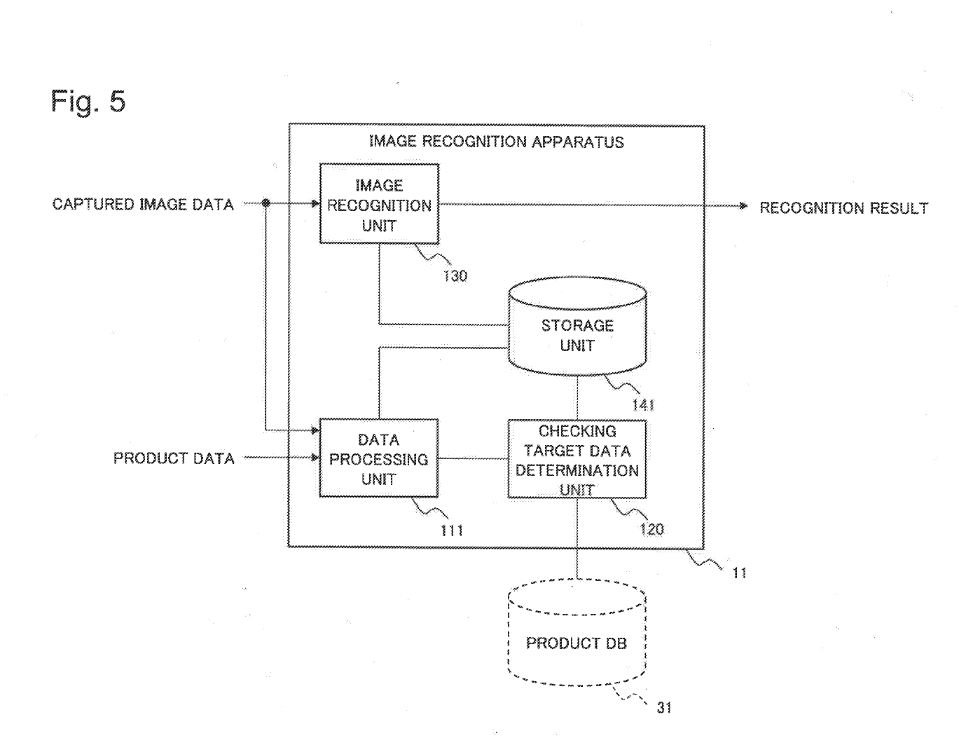

Referring to FIG. 5, a functional configuration of the image recognition apparatus 11 according to the present example embodiment will be described. FIG. 5 is a functional block diagram illustrating an example of the functional configuration of the image recognition apparatus 11 according to the present example embodiment.

As illustrated in FIG. 5, the image recognition apparatus 11 according to the present example embodiment includes a data processing unit 111, a checking target data determination unit 120, an image recognition unit 130, and a storage unit 141.

The storage unit 141 stores a database generated by the checking target data determination unit 120, similarly to the storage unit 140 according to the first example embodiment. Further, the storage unit 141 stores shelf space allocation information at a store. The shelf space allocation information is information indicating, for each shelf, a position for each product in which the product may be displayed (e.g. a position of a shelf and a position of a tier in the shelf). For example, the shelf space allocation information is information indicated for each store shelf by recommended shelf space allocation information, current layout information, instructions related to shelf space allocation, and a management history of shelf space allocation. The shelf space allocation information is not limited to the above, and, for example, may be a shelf space allocation diagram output by common shelf space allocation software, or the like. For example, the shelf space allocation information may be transmitted from an external apparatus or the like. Further, information included in the shelf space allocation information may include a type (category) of a displayed product. Further, the shelf space allocation information, may be information that varies with time (e.g. hours of the day and a day of the week).

The data processing unit 111 receives captured shelf information included in captured image data, from the imaging device 20. Then, the data processing unit 111 acquires shelf space allocation information from the storage unit 141. When shelf space allocation information is transmitted from an external apparatus or the like, the data processing unit 111 receives shelf space allocation information from the external apparatus or the like. Further, the data processing unit 111 receives product data from a POS terminal 21 and/or another apparatus.

Then, the data processing unit 111 calculates an inventory quantity of each product, based on the captured shelf information, the product data, and the shelf space allocation information. Based on shelf space allocation information with respect to a store shelf in a position matching a position of a store shelf indicated by the captured shelf information, the data processing unit 111 identifies a product that may be displayed on the store shelf.

As described above, the shelf space allocation information indicates, for each product, a position in which the product may be displayed. Accordingly, shelf space allocation information with respect to a store shelf in a position matching a position of a store shelf indicated by the captured shelf information includes a product that may be displayed on the store shelf. By extracting information indicating a product that may be displayed on the corresponding store shelf from the shelf space allocation information, the data processing unit 111 identifies a product that may be displayed on the store shelf.

Then, for each identified product, the data processing unit 111 calculates a quantity related to each product, based on the product data. Then, the data processing unit 111 outputs the calculated quantity related to each product to the checking target data determination unit 120 as product quantity information.

The checking target data determination unit 120 and the image recognition unit 130 have functions similar to those of the checking target data determination unit 120 and the image recognition unit 130, respectively, according to the first example embodiment, and therefore description thereof is omitted.

### Flow of Processing in Image Recognition Apparatus 11

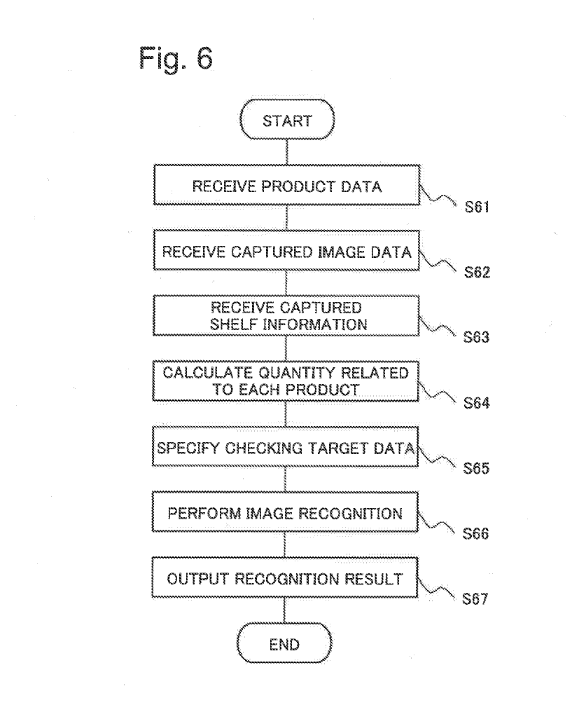

Next, referring to FIG. 6, a flow of processing in the image recognition apparatus 11 will be described. FIG. 6 is a flowchart illustrating an example of a flow of image recognition processing in the image recognition apparatus 11 according to the present example embodiment. The image recognition processing by the image recognition apparatus 11 illustrated in FIG. 6 includes the checking target data determination processing and the image recognition processing according to the aforementioned first example embodiment.

As described in FIG. 6, first, the data processing unit 111 receives product data from the POS terminal 21 and/or another apparatus (Step S61). Further, the image recognition unit 130 receives captured image data (Step S62). Further, the data processing unit 111 receives captured shelf information in the aforementioned captured image data (Step S63). The data processing unit 111 may receive the entire captured image data. Steps S61 to S63 may be performed in any order. Further, Steps S61 to S63 may be performed simultaneously.

Then, based on the received product data, captured shelf information, and shelf space allocation information, the data processing unit 111 calculates a quantity (e.g. an inventory quantity) related to each product that may be displayed on the captured store shelf, the each product being sold at the store (Step S64).

Subsequently, the checking target data determination unit 120 specifies checking target data in the product DB 31, based on the quantity of each product calculated in Step S64 (Step S65). Specifically, similarly to the first example embodiment, based on the quantity related to each product calculated in Step S64, the checking target data determination unit 120 generates, from the product DB 31, a database composed of checking target data used as a checking target when the image recognition unit 130 performs image recognition, similarly to Step S33 in FIG. 3.

Then, by using the checking target data specified by the checking target data determination unit 120 in Step S65, the image recognition unit 130 performs image recognition of a captured image represented by the captured image data (Step S66).

Then, the image recognition unit 130 outputs the recognition result (Step S67).

The above concludes the image recognition processing by the image recognition apparatus 11.

Similarly to the modified example of the aforementioned first example embodiment, the checking target data determination unit 120 may specify checking target data without generating a new database.

As described above, the image recognition apparatus 11 according to the present example embodiment is able to provide an effect similar to that provided by the aforementioned image recognition apparatus 10. Further, from shelf space allocation information with respect to a captured store shelf, the data processing unit 111 in the image recognition apparatus 11 according to the present example embodiment further identifies a product that may be displayed on the store shelf, and calculates a quantity related to the identified product. Then, the checking target data determination unit 120 specifies checking target data, based on the calculated quantity. Consequently, the image recognition apparatus 11 is able to exclude a product displayed on a shelf in the store but not on the captured store shelf from the checking target data. Accordingly, the image recognition apparatus 11 according to the present example embodiment is able to further improve recognition accuracy.

### Modified Example

While the checking target data determination unit 120 according to the aforementioned second example embodiment specifies checking target data by using product quantity information calculated by the data processing unit 111, based on captured shelf information, the method of the checking target data determination unit 120 specifying checking target data is not limited thereto.

First, similarly to the data processing unit 110 according to the first example embodiment, the data processing unit 111 calculates a quantity (referred to as first product quantity information) of each product sold at the store, based on received product data. The checking target data determination unit 120 specifies checking target data, based on the calculated first product quantity information. The specified checking target data are referred to as first checking target data. The first checking target data may be updated at a predetermined timing.

Next, when receiving captured shelf information, the data processing unit 111 calculates a quantity (referred to as second product quantity information) related to each product that may be displayed on the captured store shelf. Then, the checking target data determination unit 120 further specifies checking target data from the aforementioned first checking target data, based on the second product quantity information.

The image recognition apparatus 11 according to the modified example of the second example embodiment may specify checking target data as described above. Consequently, compared with a case that the checking target data determination unit 120 according to the second example embodiment specifies checking target data, an access count to the product DB management apparatus 30 can be reduced. The reason is that the checking target data determination unit 120 according to the present modified example accesses the product DB management apparatus 30 when specifying first checking target data but does not access the product DB management apparatus 30 when specifying second checking target data. At a store including a plurality of store shelves, access to the product DB management apparatus 30 is not performed every time an image of store shelf is captured, and therefore an access count to the product DB management apparatus 30 can be reduced.

Further, when shelf space allocation information about a store shelf related to a captured store shelf includes a product type, the data processing unit 111 may output the product type to the checking target data determination unit 120. The product type indicates a type (category) of a product that may be displayed on the captured store shelf. Then, the checking target data determination unit 120 may include product data of the received type in checking target data. Thus, the checking target data determination unit 120 is able to specify checking target data from the product DB 31, based on a product type.

Further, when checking target data do not include a product being a topic of conversation on a social networking service (SNS), the checking target data determination unit 120 may include the product data in the checking target data. Further, when checking target data include a product being a topic of conversation on an SNS, and information about the product being out of stock or the like is posted on the aforementioned SNS, the checking target data determination unit 120 may delete the product data from the checking target data. Thus, the checking target data determination unit 120 may update checking target data, based on information acquired through the Internet and the like.

### Third Example Embodiment

Next, referring to drawings, a third example embodiment of the present invention will be described. For convenience of description, a same reference sign is given to a part having a same function as a part included in a drawing described in the aforementioned first and second example embodiments, and description thereof is omitted.

A method of further improving recognition accuracy by correcting a recognition result will be described in the present example embodiment.

An image recognition system 1 according to the present example embodiment includes an image recognition apparatus 12 in place of the image recognition apparatus 10 in the image recognition system 1 according to the aforementioned first example embodiment. The remaining configuration of the image recognition system 1 according to the present example embodiment is similar to that of the image recognition system 1 according to the aforementioned first example embodiment, as illustrated in FIG. 1.

### Functional Configuration of Image Recognition Apparatus 12

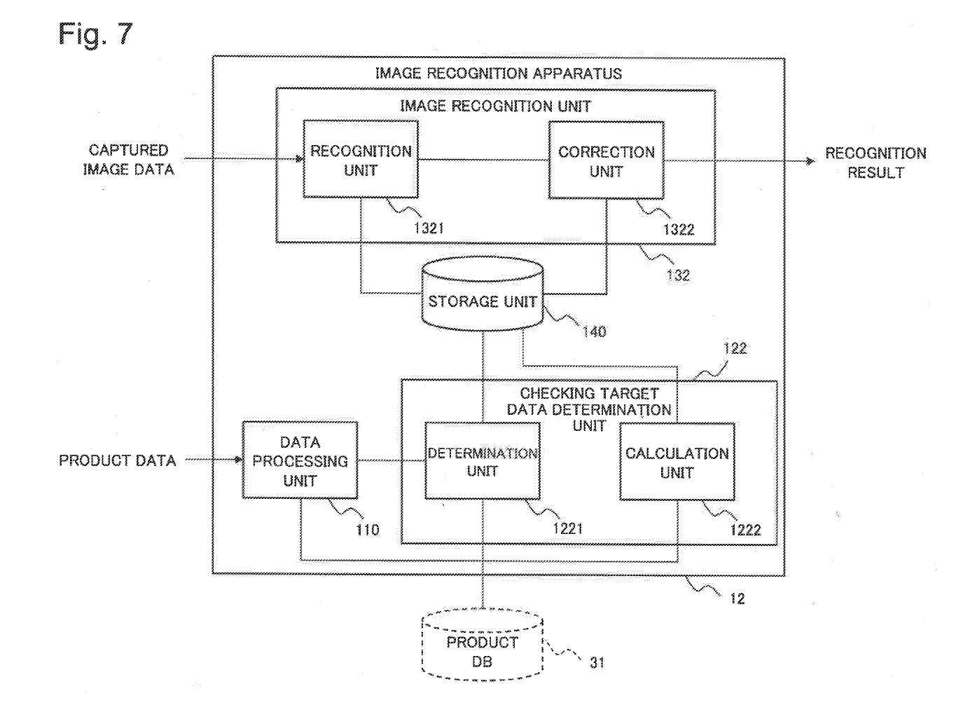

Referring to FIG. 7, a functional configuration of the image recognition apparatus 12 according to the present example embodiment will be described. FIG. 7 is a functional block diagram illustrating an example of the functional configuration of the image recognition apparatus 12 according to the present example embodiment. As illustrated in FIG. 7, the image recognition apparatus 12 according to the present example embodiment includes a data processing unit 110, a checking target data determination unit 122, an image recognition unit 132, and a storage unit 140. The image recognition apparatus 12 according to the present example embodiment includes a checking target data determination unit 122 in place of the checking target data determination unit 120 and an image recognition unit 132 in place of the image recognition unit 130 in the image recognition apparatus 10 according to the first example embodiment.

The checking target data determination unit 122 receives product quantity information calculated by the data processing unit 110 from the data processing unit 110. As illustrated in FIG. 7, the checking target data determination unit 122 includes a determination unit 1221 and a calculation unit 1222. The determination unit 1221 has a function similar to that of the checking target data determination unit 120 according to the aforementioned first example embodiment. The determination unit 1221 specifies checking target data used as a checking target when the image recognition unit 132 performs image recognition, out of data in a product DB 31, based on a quantity related to each product included in product quantity information.

The calculation unit 1222 calculates a prior probability with respect to each product sold at a store where the image recognition apparatus 12 including the calculation unit 1222 is installed, based on product quantity information. The present example embodiment obtains a proportion of a certain product to a total number of products within a predetermined range as a prior probability. For example, when an inventory quantity of a product A is denoted as N (N is a natural number), the calculation unit 1222 calculates a prior probability P_A of the product A by using P_A=N/(a total number of products within a predetermined range).

For example, the total number of products within a predetermined range may be a total number of inventory quantities of products in a store where a certain product is sold. Specifically, when a total number of inventory quantities of products in a store where a certain product is sold is denoted as S (S is a natural number), the calculation unit 1222 calculates a prior probability with respect to a product A by using P_A=N/S.

Further, the total number of products within a predetermined range may be, for example, a total number of inventory quantities of products similar to a certain product in a store where the certain product is sold.

Further, the total number of products within a predetermined range may be, for example, a total number of inventory quantities of products that may be displayed on a same store shelf as a store shelf on which a certain product may be displayed. Further, the total number of products within a predetermined range may be a total number of products in a store, on a store shelf, or the like at a predetermined time (e.g. a timing of purchase). Further, the total number of products within a predetermined range may be a hit count of the certain product being hit on an SNS.

Thus, the calculation unit 1222 calculates a prior probability with respect to each product. At this time, for example, the calculation unit 1222 may calculate a prior probability in such a way that a recognition score, to be described later, with respect to a product an inventory quantity of which is larger than that of another product is given a higher value. Then, the calculation unit 1222 stores the calculated prior probability with respect to each product in the storage unit 140, associating the probability with information (e.g. a product name) indicating a product being the target of the prior probability calculation. The calculation unit 1222 may output the prior probability to the image recognition unit 132.

The image recognition unit 132 receives captured image data from an imaging device 20. As illustrated in FIG. 7, the image recognition unit 132 includes a recognition unit 1321 and a correction unit 1322. The recognition unit 1321 has a function similar to that of the image recognition unit 130 according to the aforementioned first example embodiment. The recognition unit 1321 outputs a recognition result (referred to as a first recognition result) to the correction unit 1322. The first recognition result output by the recognition unit 1321 includes a recognition score for each product with respect to each product included in a captured image represented by captured image data. The recognition score indicates certainty of a recognition result. The recognition score according to the present example embodiment is described on the assumption that an upper limit thereof is 1.0, and a value closer to 1.0 represents higher reliability. For example, as a result of recognizing a certain product, the recognition unit 1321 outputs a recognition result that “a recognition score of a product A is 0.8, and a recognition score of a product B is 0.5.” Thus, the recognition unit 1321 outputs to the correction unit 1322, as a first recognition result, information about a recognized product (e.g. a product name) and a recognition score with respect to the product, for each product.

The correction unit 1322 receives a first recognition result from the recognition unit 1321. Further, the correction unit 1322 acquires a prior probability for each product from the storage unit 140. The correction unit 1322 corrects a first recognition result by using the acquired prior probability, and outputs the corrected recognition result (referred to as a second recognition result) as a recognition result by the image recognition apparatus 12.

Correction performed by the correction unit 1322 will be described here. For example, a first recognition result R1 with respect to a certain product is denoted as R1=(S1_A,S1_B, . . .). Note that S1_A denotes a recognition score when a certain product is recognized as a product A, and S1_B denotes a recognition score when a certain product is recognized as a product B. When a first recognition result for a certain product is “a recognition score with respect to the product A is 0.8, and a recognition score with respect to the product B is 0.5” as described above, R1 becomes R1=(0.8,0.59).

Further, a finally obtained recognition result (second recognition result) R2 is denoted as R2=(S2_A,S2_B, . . . ). Note that S2_A denotes a final recognition score when a certain product is recognized as the product A, and S2_B denotes a final recognition score when a certain product is recognized as the product B. The output format of R1 and R2 is an example, and is not limited thereto.

For example, by combining the recognition score S1_A related to the product A, the score being included in the first recognition result R1, with the prior probability P_A, the correction unit 1322 calculates a recognition score S2_A correcting the recognition score S1_A. For example, the correction unit 1322 may determine a sum of the prior probability multiplied by or not multiplied by a predetermined coefficient (denoted as a) and the recognition score included in the first recognition result to be a corrected recognition score.

Specifically, the correction unit 1322 may calculate a recognition score with respect to the product A by using S2_A=S1_A +αP_A, or S2_A=S1_A+P_A. The combining method is not particularly limited. For example, the correction unit 1322 may determine a result of multiplying the recognition score included in the first recognition result by a prior probability to be a corrected recognition score. Specifically, the correction unit 1322 may calculate a recognition score with respect to the product A by using S2_A=S1_A*P_A.

The correction unit 1322 may correct every first recognition result or may correct a first recognition result satisfying a predetermined condition. For example, the predetermined conditions include (A) and (B) described below but are not limited thereto:
(A) A recognition score with the highest value is less than a predetermined threshold value.
(A) A difference between a recognition score with the highest value and a recognition score with the second highest value is less than a predetermined value.

Then, the correction unit 1322 may output a product with the highest recognition score out of the second recognition result as a final recognition result, or may output the calculated second recognition result as the final recognition result by the image recognition apparatus 12.

For example, a case that the calculation unit 1222 calculates a prior probability in such a way that a recognition score, to be described later, with respect to a product an inventory quantity of which is larger than that of another product is given a higher value. It is assumed that a first recognition result R1 with respect to a certain product, being output by the recognition unit 1321, is given as R1=(S1_A,S1_B,S1_C)=(0.50,0.46,0.40). Then, it is further assumed that an inventory quantity of a product A is larger than inventory quantities of a product B and a product C, and the inventory quantity of the product B is larger than the inventory quantity of the product C. At this time, the calculation unit 1222 calculates each prior probability in such a way that a prior probability with respect to the product A is higher than a prior probability with respect to the product B and a prior probability with respect to the product C, and the prior probability with respect to the product B is higher than the prior probability with respect to the product C. It is assumed that the prior probabilities calculated by the calculation unit 1222 are given by (P_A,P_B,P_C)=(1.20,0.50,0.45).

Then, for example, it is assumed that the correction unit 1322 determines a product of a prior probability and a recognition score included in a first recognition result to be a corrected recognition score. Accordingly, R2 is obtained as R2=(S2_A,S2_B,S2_C)=(0.50 * 1.20,0.46 * 0.50,0.40 * 0.45)=(0.96,0.23,0.18).

Then, the correction unit 1322 outputs the second recognition result R2 or information indicating the product A with the highest recognition score. Thus, the calculation unit 1222 calculates a prior probability in such a way that a recognition score with respect to a product an inventory quantity of which is larger than that of another product is given a higher value. Consequently, the correction unit 1322 is able to correct the first recognition result, based on the prior probability. Accordingly, the image recognition apparatus 12 is able to further improve recognition accuracy.

### Flow of Processing in Image Recognition Apparatus 12

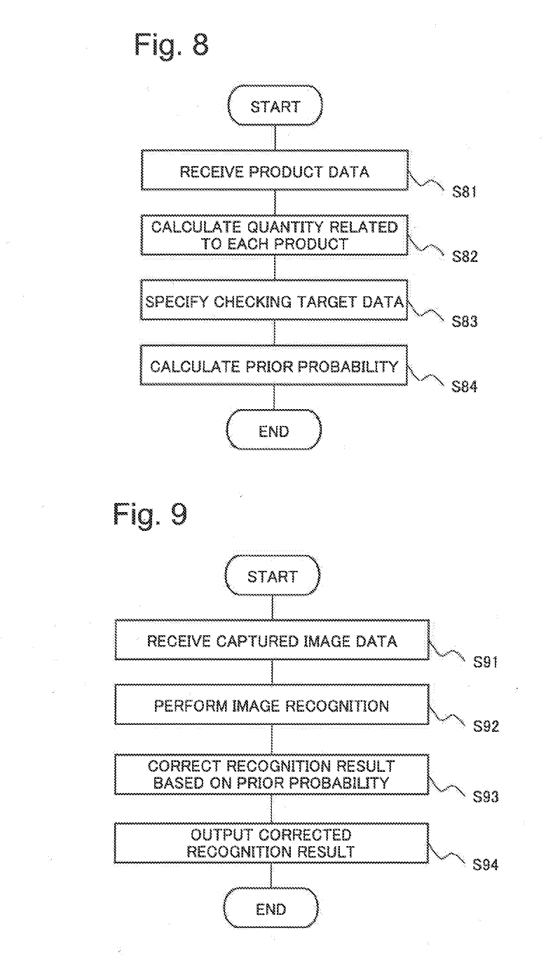

Next, referring to FIGS. 8 and 9, flows of processing in the image recognition apparatus 12 will be described. FIG. 8 is a flowchart illustrating an example of a flow of prior probability calculation processing in the image recognition apparatus 12 according to the present example embodiment.

As described in FIG. 8, first, the data processing unit 110 receives product data from the POS terminal 21 and/or another apparatus (Step S81).

Then, based on the received product data, the data processing unit 110 calculates a quantity for each product sold at a store (e.g. a sales volume, a purchase quantity, an ordering quantity, a quantity inspected, and a quantity displayed, for each product) (Step S82).

Subsequently, the determination unit 1221 in the checking target data determination unit 122 specifies checking target data in the product DB 31, based on the quantity related to each product (Step S83). Steps S81 to S83 represent processing similar to the checking target data determination processing described by using FIG. 3.

Then, the calculation unit 1222 in the checking target data determination unit 122 calculates a prior probability with respect to each product, based on the quantity related to each product (Step S84). Steps S83 and S84 may be performed simultaneously, or may be performed in inverse order.

The above concludes the prior probability calculation processing by the image recognition apparatus 12.

Next, referring to FIG. 9, image recognition processing in the image recognition apparatus 12 according to the present example embodiment will be described. FIG. 9 is a flowchart illustrating an example of a flow of the image recognition processing in the image recognition apparatus 12 according to the present example embodiment.

As described in FIG. 9, first, the image recognition unit 132 receives captured image data from the imaging device 20 (Step S91).

Next, by using the checking target data specified by the determination unit 1221 in the checking target data determination unit 122 in Step S83, the recognition unit 1321 in the image recognition unit 132 performs image recognition of a captured image represented by the captured image data (Step S92).

Next, based on the prior probability calculated by the calculation unit 1222 in the checking target data determination unit 122 in Step S84, the correction unit 1322 in the image recognition unit 132 corrects the result (first recognition result) recognized by the recognition unit 1321 in Step S92 (Step S94).

Then, the correction unit 1322 in the image recognition unit 132 outputs the corrected recognition result (second recognition result) as a recognition result by the image recognition apparatus 12 (Step S95).

The above concludes the image recognition processing by the image recognition apparatus 12.

The image recognition apparatus 12 may perform the aforementioned prior probability calculation processing and the image recognition processing synchronously or asynchronously. For example, the image recognition apparatus 12 may perform the prior probability calculation processing immediately before performing the image recognition processing.

Further, for example, the image recognition apparatus 12 may perform the prior probability calculation processing at a predetermined time, independent of an execution time of the image recognition processing. For example, the predetermined time is a time when a product is displayed in a store, a time when a product is purchased, or a time when a product is inspected, but is not limited thereto. Further, at this time, the determination unit 1221 in the checking target data determination unit 122 may update checking target data used as a checking target. Further, the image recognition apparatus 12 may perform the prior probability calculation processing every time a product is sold. Thus, the checking target data determination unit 122 is able to update a prior probability at a predetermined timing.

### Effect

The image recognition apparatus 12 according to the present example embodiment is able to provide an effect similar to that provided by the image recognition apparatus 10 according to the aforementioned first example embodiment. Further, the calculation unit 1222 calculates a prior probability, and the correction unit 1322 corrects a recognition result, based on the prior probability, and therefore the image recognition apparatus 12 according to the present example embodiment is able to further improve recognition accuracy.

Further, similarly to the checking target data determination unit 120 described in the modified example of the first example embodiment, the checking target data determination unit 122 may specify checking target data without generating a database. Even in such a case, the checking target data determination unit 122 is able to improve recognition accuracy.

### Fourth Example Embodiment

Next, referring to drawings, a fourth example embodiment of the present invention will be described. For convenience of description, a same reference sign is given to a part having a same function as a part included in a drawing described in the respective aforementioned example embodiments, and description thereof is omitted.

The checking target data determination unit 122 according to the aforementioned third example embodiment has been described to specify checking target data, based on product data in a store where the image recognition apparatus 12 is provided. Similarly to the image recognition apparatus 11 according to the second example embodiment, further use of information about a captured shelf as product data will be described in the present example embodiment.

An image recognition system 1 according to the present example embodiment includes an image recognition apparatus 13 in place of the image recognition apparatus 10 in the image recognition system 1 according to the aforementioned first example embodiment. As illustrated in FIG. 1, the remaining configuration of the image recognition system 1 according to the present example embodiment is similar to that of the image recognition system 1 according to the aforementioned first example embodiment.

Similarly to the second example embodiment, captured image data representing an image captured by an imaging device 20, according to the present example embodiment, includes captured shelf information indicating which store shelf is captured in the captured image data.

### Functional Configuration of Image Recognition Apparatus 13

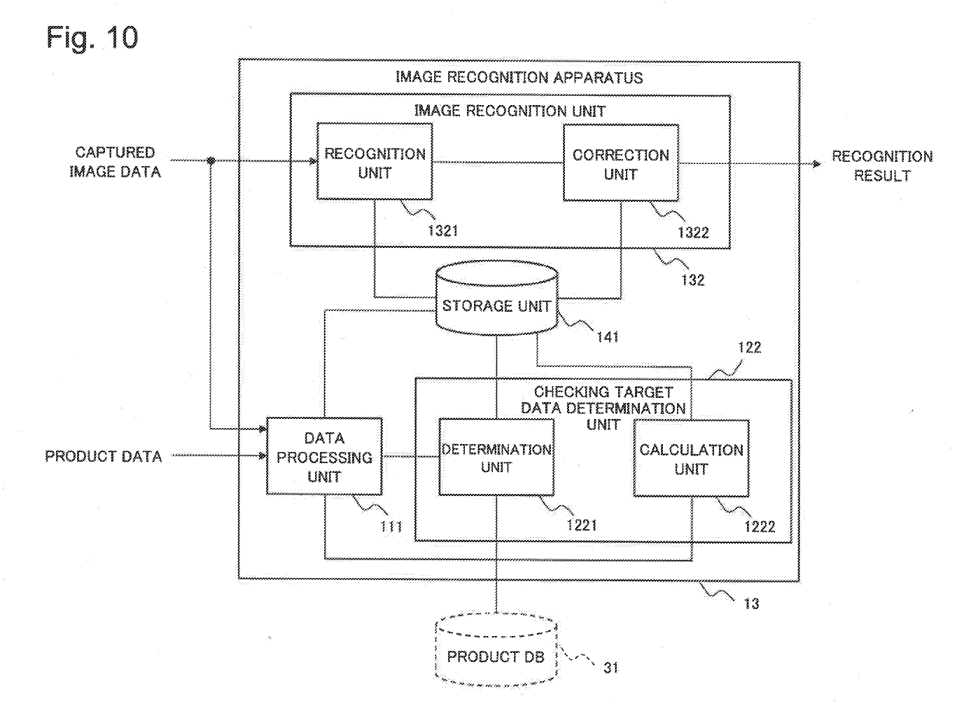

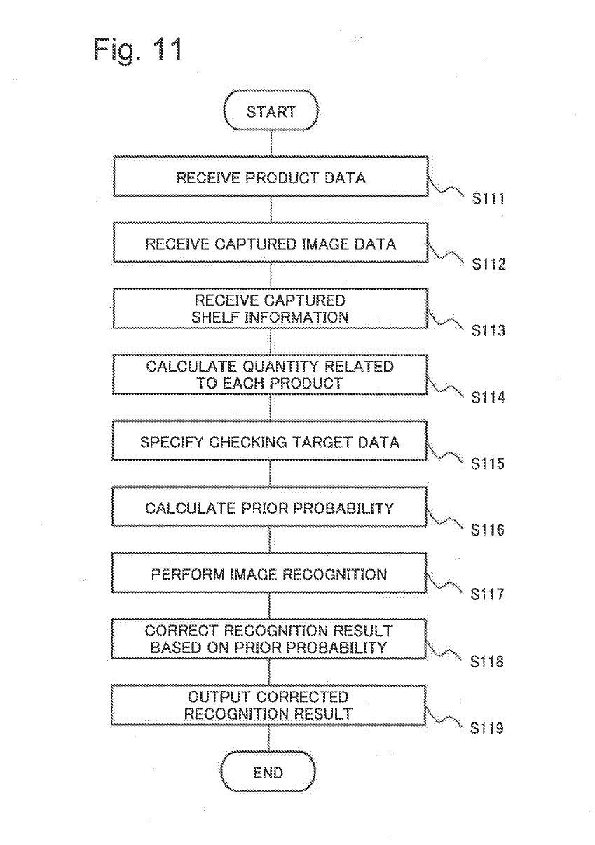

Referring to FIG. 10, a functional configuration of the image recognition apparatus 13 according to the present example embodiment will be described. FIG. 10 is a functional block diagram illustrating an example of the functional configuration of the image recognition apparatus 13 according to the present example embodiment.

As illustrated in FIG. 10, the image recognition apparatus 13 according to the present example embodiment includes a data processing unit 111, a checking target data determination unit 122, an image recognition unit 132, and a storage unit 141.

The storage unit 141 and the data processing unit 111 have functions similar to those of the storage unit 141 and the data processing unit 111, according to the second example embodiment, respectively. Further, the checking target data determination unit 122 and the image recognition unit 132 have functions similar to the checking target data determination unit 122 and the image recognition unit 132, according to the third example embodiment, respectively.

### Flow of Processing in Image Recognition Apparatus 13

Next, referring to FIG. 11, a flow of processing in the image recognition apparatus 13 will be described. FIG. 11 is a flowchart illustrating an example of a flow of image recognition processing in the image recognition apparatus 13 according to the present example embodiment. The image recognition processing by the image recognition apparatus 13, being illustrated in FIG. 11, includes the prior probability calculation processing and the image recognition processing, according to the aforementioned third example embodiment.

As described in FIG. 11, first, the data processing unit 111 receives product data from a POS terminal 21 and/or another apparatus (Step S111). Further, the image recognition unit 132 receives captured image data (Step S112). Further, the data processing unit 111 receives captured shelf information in the aforementioned captured image data (Step S113). The data processing unit 111 may receive the entire captured image data. Steps S111 to S113 may be performed in any order. Further, Steps S111 to S113 may be performed simultaneously.

Then, based on the received product data, the data processing unit 111 calculates a quantity related to each product that may be displayed on the captured store shelf, the each product being sold at the store (Step S114).

Subsequently, a determination unit 1221 in the checking target data determination unit 122 specifies checking target data in the product DB 31, based on the quantity of each product calculated in Step S114 (Step S115).

Then, a calculation unit 1222 in the checking target data determination unit 122 calculates a prior probability with respect to each product, based on the quantity related to each product (Step S116). Steps S115 and S116 may be performed simultaneously, or may be performed in inverse order.

Then, by using the checking target data specified by the determination unit 1221 in the checking target data determination unit 122 in Step S115, a recognition unit 1321 in the image recognition unit 132 performs image recognition of a captured image represented by the captured image data (Step S117). Step S117 has only to be performed after Step S115, and may be performed before Step S116 or simultaneously with Step S116.

Next, based on the prior probability calculated by the calculation unit 1222 in the checking target data determination unit 122 in Step S116, a correction unit 1322 in the image recognition unit 132 corrects the result (first recognition result) recognized by the recognition unit 1321 in Step S117 (Step S118).

Then, the correction unit 1322 in the image recognition unit 132 outputs the corrected recognition result (second recognition result) as a recognition result by the image recognition apparatus 13 (Step S119).

The above concludes the image recognition processing by the image recognition apparatus 13.

Similarly to the respective aforementioned example embodiments, the checking target data determination unit 122 may specify checking target data without generating a new database.

Further, similarly to the aforementioned second example embodiment, the data processing unit 111 may calculate a first product quantity information, and the checking target data determination unit 122 may specify checking target data, based on the calculated first product quantity information. Then, when receiving captured shelf information, the data processing unit 111 may calculate second product quantity information related to each product that may be displayed on the captured store shelf. Additionally, the checking target data determination unit 122 may specify checking target data from the aforementioned first checking target data, based on the second product quantity information.

Further, similarly to the second example embodiment, the checking target data determination unit 122 may specify checking target data from the product DB 31, based on a product type. Further, a product being a target of prior probability calculation by the calculation unit 1222 in the checking target data determination unit 122 may be each product that is highly likely to be displayed on the captured shelf, based on the captured shelf information.

As described above, the image recognition apparatus 13 according to the present example embodiment is able to provide effects similar to those provided by the image recognition apparatuses according to the respective aforementioned example embodiments.

### Fifth Example Embodiment

Next, referring to drawings, a fifth example embodiment of the present invention will be described. For convenience of description, a same reference sign is given to a part having a same function as a part included in a drawing described in the respective aforementioned example embodiments, and description thereof is omitted.

While the image recognition apparatuses according to the respective aforementioned example embodiments have been described to specify checking target data, an apparatus including the product DB 31 may specify checking target data. The configuration will be described in the present example embodiment.

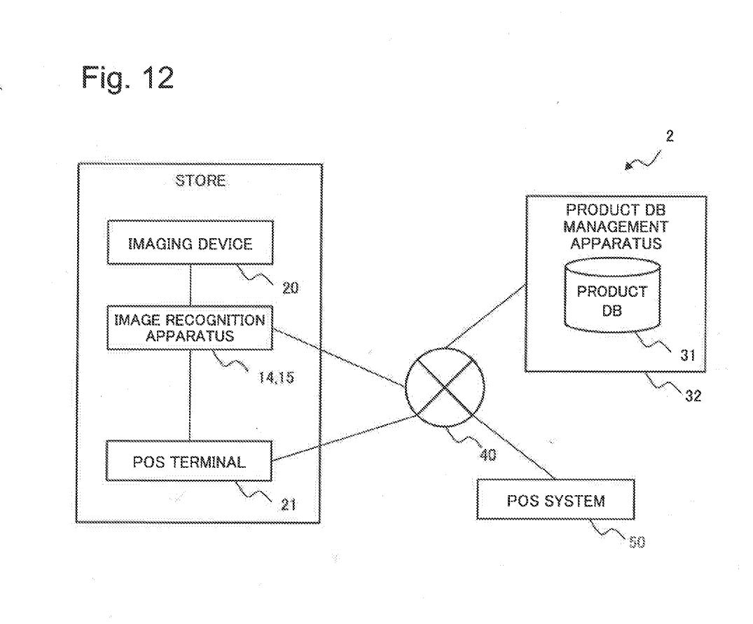

First, referring to FIG. 12, an entire configuration of an image recognition system 2 according to the present example embodiment will be described. FIG. 12 is a diagram illustrating an example of the entire configuration of the image recognition system 2 including an image recognition apparatus according to the present example embodiment. As illustrated in FIG. 12, the image recognition system 2 according to the present example embodiment includes an image recognition apparatus 14, an imaging device 20, a POS terminal 21, a product DB management apparatus 32, and a POS system 50. The image recognition apparatus 14, the POS terminal 21, the product DB management apparatus 32, and the POS system 50 are communicably connected to one another through a network 40. Further, the image recognition apparatus 14 is communicably connected to the imaging device 20 and the POS terminal 21. Note that the image recognition system 2 illustrated in FIG. 12 illustrates a configuration characteristic of the present example embodiment, and it goes without saying that the image recognition system 2 illustrated in FIG. 12 may include a part not illustrated in FIG. 12.

Similarly to the aforementioned product DB management apparatus 30, the product DB management apparatus 32 manages a database (product DB 31) storing information about a plurality of products. Further, the product DB management apparatus 32 receives product data from the POS system 50.

The POS system 50 communicates with one or more POS terminals 21 installed at each store, and receives from a POS terminal 21, for example, information in a store where the POS terminal 21 is installed about a product sold at the store. The POS system 50 receives as information about a product sold at the store, for example, information about sales (sales information) of each product. The POS system 50 is a system managing the received sales information for each product name and for each store. It is assumed, for example, that the sales information is common POS data including a sales figure and a sales volume of a certain product, but the sales information is not limited thereto. It is hereinafter assumed that information (product data) managed by the POS system 50 is product data received from a POS terminal 21 by each image recognition apparatus, according to the respective aforementioned example embodiments.

While FIG. 12 illustrates that the POS system 50 is provided separately from the store where the POS terminal 21 is installed, the installation location of the POS system 50 is not limited thereto. The

POS system 50 may be provided for each store. Further, the POS system 50 may be integrated with the POS terminal 21. Further, the POS system 50 may be provided in the product DB management apparatus 32. The POS system 50 transmits managed product data to the image recognition apparatus 14.

Further, the image recognition apparatus 14 may acquire product data from the POS system 50 and another apparatus other than the POS terminal 21. Further, the image recognition apparatus 14 receives captured image data from one or more imaging devices 20 installed at a store where the image recognition apparatus 14 is installed.

While only one store is included in the image recognition system 2 illustrated in FIG. 12 for convenience of description, there may be a plurality of stores.

### Functional Configurations of Image Recognition Apparatus 14 and Product DB Management Apparatus 32

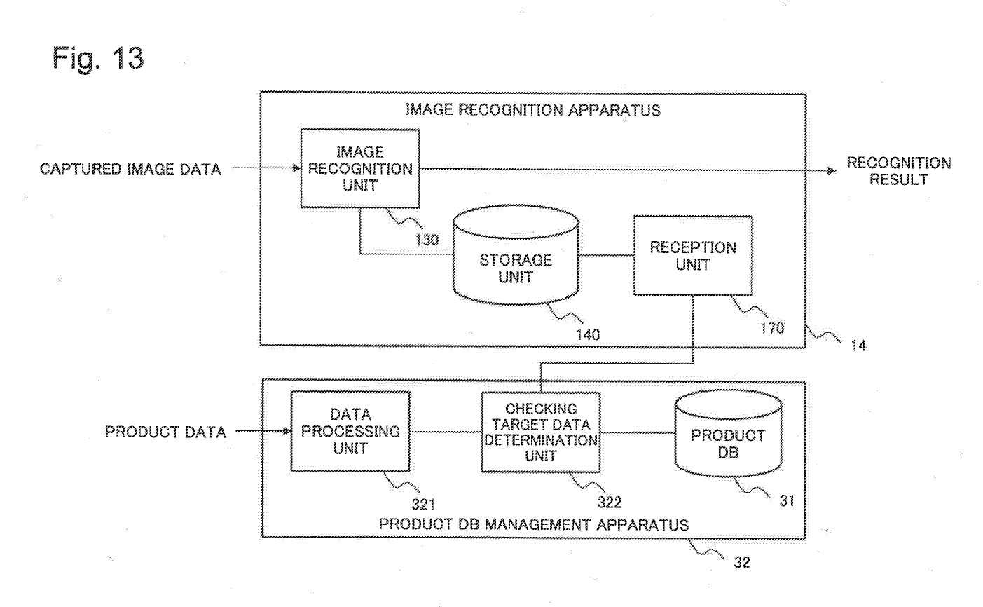

Next, referring to FIG. 13, functional configurations of the image recognition apparatus 14 and the product DB management apparatus 32, according to the present example embodiment, will be described. FIG. 13 is a functional block diagram illustrating an example of the functional configurations of the image recognition apparatus 14 and the product DB management apparatus 32, according to the present example embodiment.

As illustrated in FIG. 13, the image recognition apparatus 14 according to the present example embodiment includes an image recognition unit 130, a storage unit 140, and a reception unit 170. Further, the product DB management apparatus 32 includes a data processing unit 321, a checking target data determination unit 322, and the product DB 31.

The data processing unit 321 in the product DB management apparatus 32 has a function similar to that of the aforementioned data processing unit 110 or data processing unit 111. The data processing unit 321 receives product data from the POS system 50. Then, for each store, the data processing unit 321 calculates a quantity related to each product sold at the store, based on at least one item of sales information, purchase information, and ordering information, being included in the product data. The data processing unit 321 outputs the product quantity information calculated for each store to the checking target data determination unit 322.

The checking target data determination unit 322 has a function similar to that of the aforementioned checking target data determination unit 120 or checking target data determination unit 122. The checking target data determination unit 322 receives product quantity information for each store from the data processing unit 321. Then, based on a quantity related to each product, the quantity being included in the product quantity information with respect to a store, the checking target data determination unit 322 specifies, for each store, checking target data used as a checking target when the image recognition unit 130 in the store performs image recognition, out of data in the product DB 31.

The checking target data determination unit 322 transmits information indicating the specified checking target data, or the checking target data themselves to the image recognition apparatus 14 in a related store.

The reception unit 170 in the image recognition apparatus 14 receives information indicating specified checking target data, or the checking target data themselves from the product DB management apparatus 32. First, a case that the reception unit 170 in the image recognition apparatus 14 receives the checking target data themselves will be described. In this case, the reception unit 170 stores the received checking target data in the storage unit 140. Consequently, similarly to the storage unit 140 according to the first example embodiment, the storage unit 140 stores a database composed of checking target data.

Further, it is assumed that the reception unit 170 in the image recognition apparatus 14 receives information indicating the checking target data. In this case, the reception unit 170 stores in the storage unit 140 information required for the checking target data indicated by the received information to be used by the image recognition unit 130 as checking target data when the image recognition unit 130 performs image recognition. For example, when the information indicating the checking target data is a product name associated with data used as the checking target data, the reception unit 170 stores the product name in the storage unit 140.

Further, for example, when the information indicating the checking target data is a flag generated depending on whether in use for image recognition or not, out of data in the product DB 31, the reception unit 170 stores the flag in the storage unit 140.

Further, for example, it is assumed that the checking target data determination unit 322 generates a view composed of data used as checking target data from a table included in the product DB 31, and transmits a location of the view to the reception unit 170 as the information indicating the checking target data. In this case, the reception unit 170 may store the location of the view (a name of the view) in the storage unit 140.

The reception unit 170 according to the present example embodiment is described on the assumption that the reception unit 170 receives checking target data themselves. Further, the reception unit 170 may output the received checking target data directly to the image recognition unit 130.

Similarly to the image recognition unit 130 described in the respective example embodiments, by using an image received from the imaging device 20, the image recognition unit 130 recognizes a recognition target product included in the captured image from specified checking target data, and outputs the recognition result.

### Flow of Processing in Product DB Management Apparatus 32

Next, a flow of processing in the product DB management apparatus 32 will be described. The flow of processing in the product DB management apparatus 32 is similar to the flowchart illustrated in FIG. 3, and therefore will be described referring to FIG. 3.

First, the data processing unit 321 in the product DB management apparatus 32 receives product data from the POS system 50 (Step S31).

Then, based on the received product data, the data processing unit 321 calculates, for each store, a quantity of each product sold at a store (e.g. a sales volume, a purchase quantity, an ordering quantity, a quantity inspected, and a quantity displayed, for each product) (Step S32).

Subsequently, based on the quantity related to each product, the checking target data determination unit 322 specifies, for each store, checking target data in the product DB 31 (Step S33). Specifically, based on the quantity for each product calculated in Step S32, the checking target data determination unit 322 transmits to the image recognition apparatus 14 checking target data themselves used by the image recognition apparatus 14 as a checking target when the image recognition apparatus 14 performs image recognition, from the product DB 31.

The above concludes the checking target data determination processing by the product DB management apparatus 32.

### Flow of Processing in Image Recognition Apparatus 14

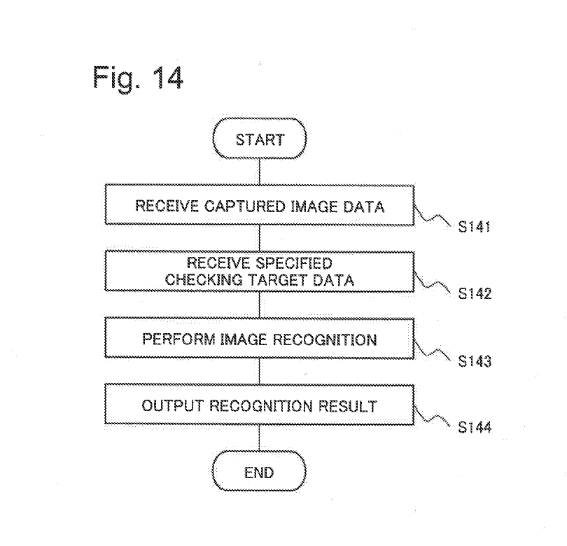

Next, referring to FIG. 14, image recognition processing in the image recognition apparatus 14 according to the present example embodiment will be described. FIG. 14 is a flowchart illustrating an example of a flow of the image recognition processing in the image recognition apparatus 14 according to the present example embodiment.

As described in FIG. 14, first, the image recognition unit 130 receives captured image data from the imaging device 20 (Step S141).

Further, the reception unit 170 receives specified checking target data or information indicating the checking target data from the product DB management apparatus 32 (Step S142).

Next, based on the received checking target data, the image recognition unit 130 performs image recognition of a captured image represented by the captured image data (Step S143).

Then, the image recognition unit 130 outputs the recognition result (Step S144).

The above concludes the image recognition processing by the image recognition apparatus 14.

The image recognition apparatus 14 may perform the aforementioned checking target data determination processing and the image recognition processing synchronously or asynchronously. For example, the image recognition apparatus 14 may perform the checking target data determination processing immediately before performing the image recognition processing.

Further, for example, the image recognition apparatus 14 may perform the checking target data determination processing at a predetermined time, independent of an execution time of the image recognition processing.

### Effect

As described above, the image recognition system 2 according to the present example embodiment is able to provide an effect similar to that provided by the image recognition system 1 according to the aforementioned first example embodiment.

### Sixth Example Embodiment

Next, referring to drawings, a sixth example embodiment of the present invention will be described. For convenience of description, a same reference sign is given to a part having a same function as a part included in a drawing described in the respective aforementioned example embodiments, and description thereof is omitted.

An image recognition apparatus further specifying checking target data specified by the aforementioned product DB management apparatus 32, by using information about a captured shelf, will be described in the present example embodiment.

An image recognition system 2 according to the present example embodiment includes an image recognition apparatus 15 in place of the image recognition apparatus 14 in the image recognition system 2 according to the aforementioned fifth example embodiment. The remaining configuration of the image recognition system 2 according to the present example embodiment is similar to that of the image recognition system 2 according to the aforementioned fifth example embodiment, as illustrated in FIG. 12.

Similarly to the second example embodiment, captured image data representing an image captured by an imaging device 20, according to the present example embodiment, include captured shelf information indicating which store shelf is captured in the captured image data.

### Functional Configurations of Image Recognition Apparatus 15 and Product DB Management Apparatus 32

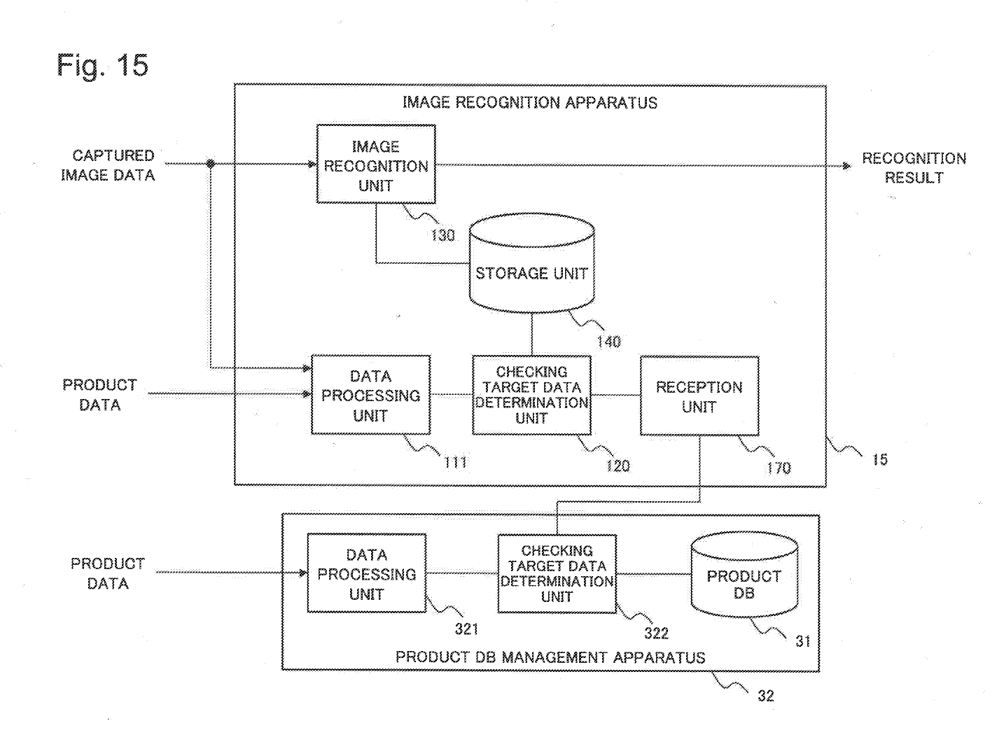

Next, referring to FIG. 15, functional configurations of the image recognition apparatus 15 and a product DB management apparatus 32, according to the present example embodiment will be described. FIG. 15 is a functional block diagram illustrating an example of functional configurations of the image recognition apparatus 15 and the product DB management apparatus 32, according to the present example embodiment.

As illustrated in FIG. 15, the image recognition apparatus 15 according to the present example embodiment includes a data processing unit 111, a checking target data determination unit (second data determination unit) 120, an image recognition unit 130, a storage unit 140, and a reception unit 170. Further, the product DB management apparatus 32 includes a data processing unit 321, a checking target data determination unit (first data determination unit) 322, and a product DB 31.

A function and an operation of the product DB management apparatus 32 according to the present example embodiment are similar to those of the product DB management apparatus 32 according to the aforementioned fifth example embodiment, and therefore description thereof is omitted.

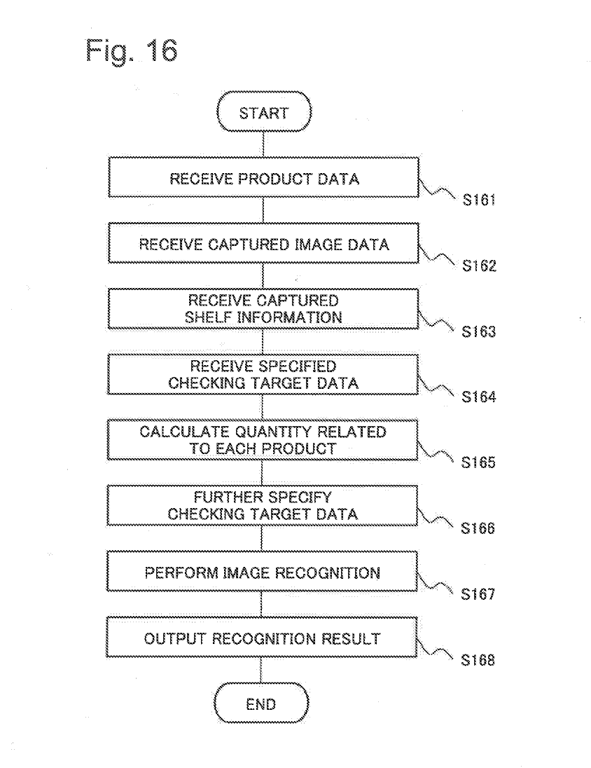

Referring to a flowchart in FIG. 16, an operation of each part in the image recognition apparatus 15 according to the present example embodiment will be described. FIG. 16 is a flowchart illustrating an example of a flow of image recognition processing in the image recognition apparatus 15 according to the present example embodiment.

As described in FIG. 16, first, the data processing unit 111 receives product data from a POS terminal 21 and/or another apparatus (Step S 161). Further, the image recognition unit 130 receives captured image data (Step S162). Further, the data processing unit 111 receives captured shelf information in the aforementioned captured image data (Step S163). The data processing unit 111 may receive the entire captured image data. The reception unit 170 receives specified checking target data or information indicating the checking target data from the product DB management apparatus 32 (Step S164).

Steps S161 to S164 may be performed in any order. Further, Steps S161 to S164 may be performed simultaneously.

Then, based on the received product data, the data processing unit 111 calculates a quantity related to each product that may be displayed on the captured store shelf, the each product being sold at a store (Step S165). Step S165 may be performed before Step S164, or may be performed simultaneously with Step S164.

Subsequently, based on the quantity for each product calculated in Step S165, the checking target data determination unit 120 further specifies the specified checking target data received in Step S164 or specified checking target data indicated by the received information (Step S166).

Then, by using the checking target data specified by the checking target data determination unit 120 in Step S166, the image recognition unit 130 performs image recognition of a captured image represented by the captured image data (Step S167).

Then, the image recognition unit 130 outputs the recognition result (Step S168).

The above concludes the image recognition processing by the image recognition apparatus 15.

The checking target data determination unit 120 may specify checking target data from the product DB 31, based on a product type.

The image recognition system 2 according to the present example embodiment is able to provide an effect similar to that provided by the aforementioned image recognition system 1. Additionally, the image recognition system 2 according to the present example embodiment further specifies, in the image recognition apparatus 15, checking target data specified by the product DB management apparatus 32, and therefore is able to further improve recognition accuracy.

### Seventh Example Embodiment

Next, referring to drawings, a seventh example embodiment of the present invention will be described. For convenience of description, a same reference sign is given to a part having a same function as a part included in a drawing described in the respective aforementioned example embodiments, and description thereof is omitted.

An image recognition system 1 according to the present example embodiment includes an image recognition apparatus 16 in place of the image recognition apparatus 10 in the image recognition system 1 according to the aforementioned first example embodiment. The remaining configuration of the image recognition system 1 according to the present example embodiment is similar to that of the image recognition system 1 according to the aforementioned first example embodiment, as illustrated in FIG. 1.

While the image recognition apparatuses according to the respective aforementioned example embodiments specify checking target data in order to improve recognition accuracy, a method of improving recognition accuracy without specifying checking target data will be described in the present example embodiment.

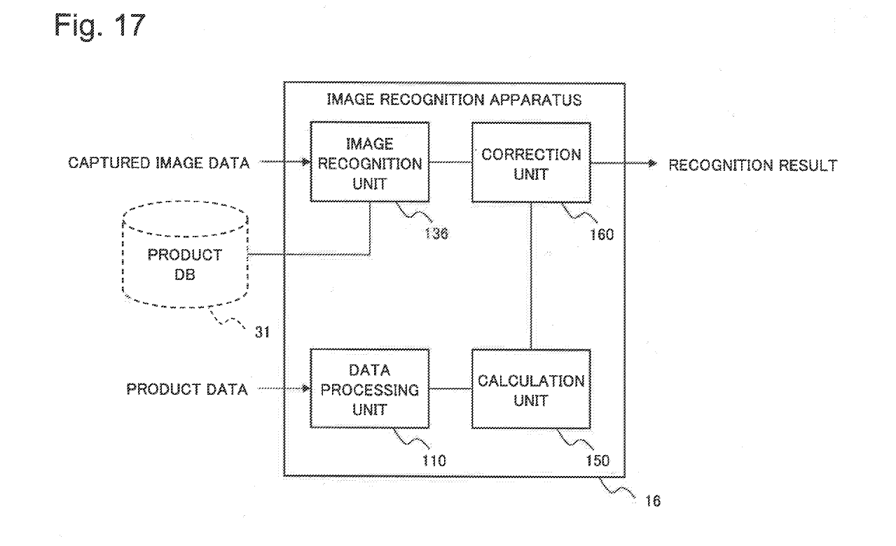

FIG. 17 is a diagram illustrating an example of a functional configuration of the image recognition apparatus 16 according to the present example embodiment. As illustrated in FIG. 17, the image recognition apparatus 16 includes an image recognition unit 136, a calculation unit 150, and a correction unit 160. Further, the image recognition apparatus 16 may additionally include a data processing unit 110. Further, the data processing unit 110 may be included in the calculation unit 150.

Similarly to the aforementioned data processing unit 110, the data processing unit 110 receives product data from a POS terminal 21 and/or another apparatus. Then, based on sales information, purchase information, and ordering information, being included in the product data, the data processing unit 110 calculates a quantity related to each product sold at a store. The data processing unit 110 outputs the calculated quantity (product quantity information) to the calculation unit 150.

The calculation unit 150 has a function of the calculation unit 1222 according to the third example embodiment. The calculation unit 150 receives product quantity information calculated by the data processing unit 110 from the data processing unit 110. Based on the received product quantity information, the calculation unit 150 calculates a prior probability with respect to each product sold at a store where the image recognition apparatus 16 including the calculation unit 150 is installed. The calculation method of a prior probability by the calculation unit 150 is similar to the aforementioned calculation unit 1222, and therefore description thereof is omitted. The calculation unit 150 outputs the calculated prior probability to the correction unit 160. The calculation unit 150 may store the calculated prior probability in an unillustrated storage device, associating the probability with information (e.g. a product name) indicating a product being the target of the prior probability calculation.

The image recognition unit 136 receives captured image data from an imaging device 20. Then, the image recognition unit 136 performs image recognition of an image (target image) represented by the received captured image data, by using a product DB 31 storing information about a plurality of products. The image recognition unit 136 outputs the recognition result as a first recognition result to the correction unit 160. It is assumed that the first recognition result output by the image recognition unit 136 has a format similar to that of the first recognition result output by the aforementioned recognition unit 1321. That is to say, the first recognition result output by the image recognition unit 136 includes a recognition score for each product, with respect to each product included in a captured image represented by the captured image data.

The correction unit 160 has a function of the correction unit 1322 according to the third example embodiment. The correction unit 160 receives a first recognition result from the image recognition unit 136. Further, the correction unit 160 acquires a prior probability for each product from the calculation unit 150. Then, by using the acquired prior probability, the correction unit 160 corrects the first recognition result, and outputs the corrected recognition result (second recognition result) as a recognition result by the image recognition apparatus 16.

The correction method of a recognition result by the correction unit 160 is similar to that by the aforementioned correction unit 1322, and therefore description thereof is omitted.

### Flow of Processing in Image Recognition Apparatus 16

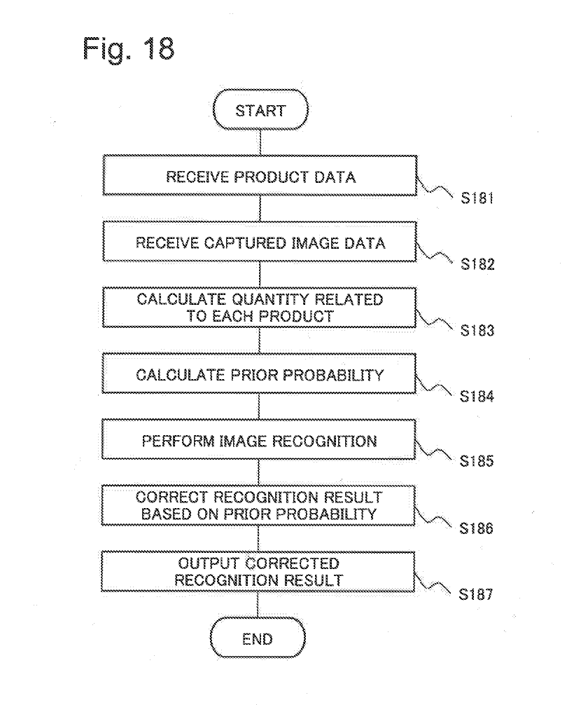

Next, referring to FIG. 18, a flow of processing in the image recognition apparatus 16 will be described. FIG. 18 is a flowchart illustrating an example of a flow of image recognition processing in the image recognition apparatus 16 according to the present example embodiment.

As described in FIG. 18, first, the data processing unit 110 receives product data from the POS terminal 21 and/or another apparatus (Step S181). Further, the image recognition unit 136 receives captured image data (Step S182). Steps S181 and S182 may be performed simultaneously, or may be performed in inverse order.

Then, based on the received product data, the data processing unit 110 calculates a quantity for each product sold at the store (e.g. a sales volume, a purchase quantity, an ordering quantity, a quantity inspected, and a quantity displayed, for each product) (Step S 183).

Subsequently, based on the quantity related to each product, the calculation unit 150 calculates a prior probability with respect to each product (Step S 184).

Further, the image recognition unit 136 performs image recognition of a captured image represented by the captured image data (Step S185). Step S185 has only to be performed after Step S182.

Next, based on the prior probability calculated by the calculation unit 150 in Step S184, the correction unit 160 corrects the result (first recognition result) recognized by the image recognition unit 136 in Step S185 (Step S186).

Then, the correction unit 160 outputs the corrected recognition result (second recognition result) as a recognition result by the image recognition apparatus 16 (Step S187).

The above concludes the image recognition processing by the image recognition apparatus 16.

While the processing in the respective units in the image recognition apparatus 16 has been described as a series of processing in the flowchart in FIG. 18, the processing of performing image recognition (Steps S182 and S185 to S187) and the processing of performing prior probability calculation (Steps S181, S183, and S184) may be performed at different timings.

As described above, similarly to the calculation unit 1222, the calculation unit 150 in the image recognition apparatus 16 according to the present example embodiment calculates a prior probability in such a way that a recognition score with respect to a product an inventory quantity of which is larger than that of another product is given a value higher than a recognition score with respect to the another product. Then, similarly to the correction unit 1322, the correction unit 160 corrects a recognition result with respect to a recognition target product included in a captured image, based on the prior probability.

Thus, by correcting an image recognition result by a prior probability, the image recognition apparatus 16 according to the present example embodiment is able to, for example, cause a product an inventory quantity of which is larger than another product more likely to be recognized. Consequently, the image recognition apparatus 16 according to the present example embodiment is able to prevent recognition as an out-of-stock product. Accordingly, the image recognition apparatus 16 according to the present example embodiment is able to improve recognition accuracy.

### Eighth Example Embodiment

Next, an eighth example embodiment of the present invention will be described. A minimum configuration solving the problem of the present invention, the configuration underlying the image recognition apparatuses according to the aforementioned first to fourth example embodiments, will be described in the present example embodiment.

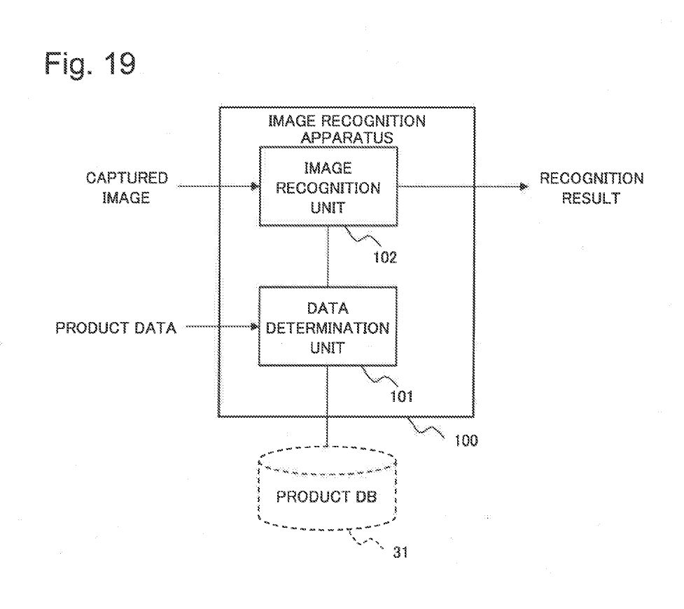

FIG. 19 is a diagram illustrating a functional configuration of an image recognition apparatus 100 according to the present example embodiment. As illustrated in FIG. 19, the image recognition apparatus 100 includes a data determination unit 101 and an image recognition unit 102.

The data determination unit 101 is equivalent to the aforementioned checking target data determination unit (120, 122). The data determination unit 101 receives product data related to a product sold at a store from, for example, a POS terminal. Based on the received product data, the data determination unit 101 specifies checking target data being data of a checking target from a database (product DB 31) storing information about a plurality of products. The data determination unit 101 outputs the specified checking target data to the image recognition unit 102.

The image recognition unit 102 is equivalent to the aforementioned image recognition unit (130, 132). The image recognition unit 102 receives specified checking target data from the data determination unit 101. Then, by using a captured image captured at the store, the image recognition unit 102 recognizes a recognition target product included in the captured image, from the specified checking target data.

Consequently, by checking the checking target data against the recognition target product, the image recognition apparatus 100 according to the present example embodiment is able to recognize the recognition target product. A large amount of checking target data to be checked causes a variation in recognition results, and recognition accuracy decreases. However, a number of products included in the checking target data specified by the image recognition apparatus 100 according to the present example embodiment is less than a number of products included in the product DB 31. Accordingly, the image recognition apparatus 100 according to the present example embodiment is able to improve recognition accuracy.

Further, the image recognition apparatus 100 according to the present example embodiment is able to reduce the time required for checking, compared with a case that entire data related to products included in the product DB 31 storing information about a plurality of products are checked against a recognition target product. Additionally, the image recognition apparatus 100 according to the present example embodiment is able to reduce communication traffic with an apparatus including the product DB 31 when performing image recognition.

### Ninth Example Embodiment

Next, a ninth example embodiment of the present invention will be described. A configuration underlying the image recognition systems according to the aforementioned fifth and sixth example embodiments will be described in the present example embodiment.

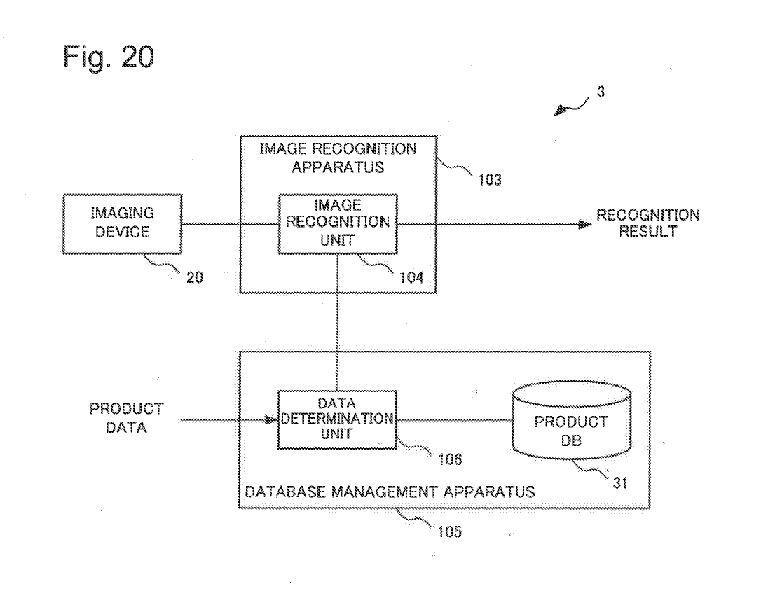

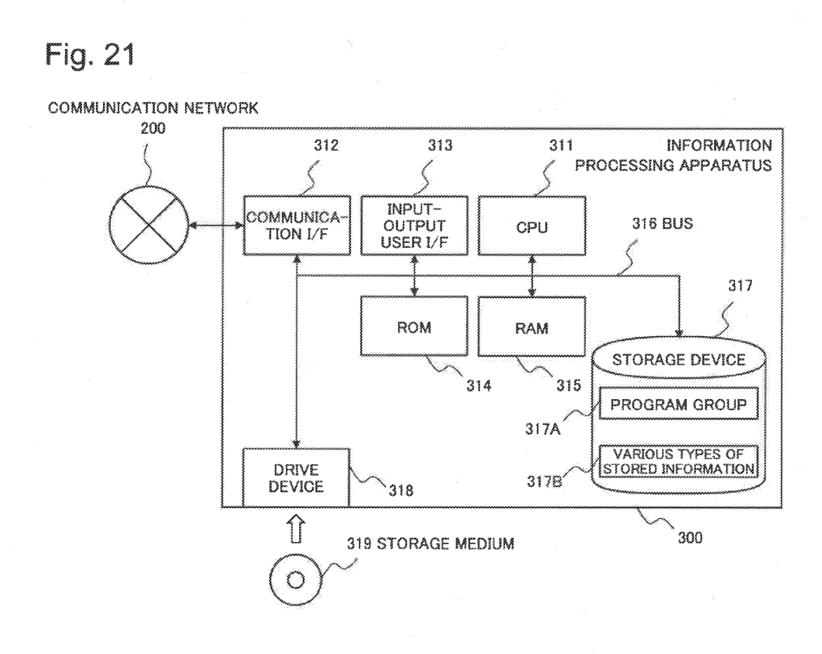

FIG. 20 is a diagram illustrating a functional configuration of an image recognition system 3 according to the present example embodiment. As illustrated in FIG. 20, the image recognition system 3 includes an image recognition apparatus 103, a database management apparatus 105, and an imaging device 20. The image recognition apparatus 103 includes an image recognition unit 104. Further, the database management apparatus 105 includes a data determination unit (first data determination unit) 106.

The imaging device 20 has a function similar to that of the imaging device 20 according to the aforementioned fifth and sixth example embodiments. The imaging device 20 captures an image of a product sold at a store. The imaging device 20 outputs the image being captured (captured image) to the image recognition apparatus 103.

The database management apparatus 105 manages a database (product DB 31) storing information about a plurality of products. The data determination unit 106 included in the database management apparatus 105 is equivalent to the aforementioned checking target data determination unit 322. The data determination unit 106 receives product data related to a product sold at a store from, for example, a POS terminal. Based on product data received from the product DB 31, the data determination unit 106 specifies checking target data being data of a checking target. The data determination unit 106 outputs the specified checking target data to the image recognition unit 104.

The image recognition apparatus 103 receives a captured image captured by the imaging device 20. The image recognition unit 104 in the image recognition apparatus 103 is equivalent to the aforementioned image recognition unit 130. The image recognition unit 104 receives specified checking target data from the data determination unit 106. Then, by using the captured image, the image recognition unit 104 recognizes a recognition target product included in the captured image, from the specified checking target data.

Consequently, by checking the checking target data against the recognition target product, the image recognition system 3 according to the present example embodiment is able to recognize the recognition target product. A large amount of checking target data to be checked causes a variation in recognition results, and recognition accuracy decreases. However, a number of products included in the checking target data specified by the image recognition system 3 according to the present example embodiment is less than a number of products included in the product DB 31. Accordingly, the image recognition system 3 according to the present example embodiment is able to improve recognition accuracy.

### Hardware Configuration Example

A hardware configuration example that may provide the image recognition apparatus (10 to 16, 100, 103), the product DB management apparatus (30, 32), and the database management apparatus 105, according to the respective aforementioned example embodiments, will be described. The aforementioned image recognition apparatus (10 to 16, 100, 103), product DB management apparatus (30, 32) and database management apparatus 105 may be provided as dedicated apparatuses but may also be provided by using a computer (information processing apparatus).

FIG. 21 is a diagram exemplifying a hardware configuration of a computer (information processing apparatus) that is able to provide the respective example embodiments of the present invention.

Hardware of the information processing apparatus (computer) 300 illustrated in FIG. 21 includes the following parts:
a central processing unit (CPU) 311,
a communication interface (I/F) 312, an input-output user interface 313,
a read only memory (ROM) 314,
a random access memory (RAM) 315,
a storage device 317, and
a drive device 318 for a computer-readable storage medium 319.

Further, the parts are connected with one another through a bus 316. The input-output user interface 313 is a man-machine interface such as a keyboard as an example of an input device, a display as an example of an output device, and the like. The communication interface 312 is a common communication means for the apparatuses according to the respective aforementioned example embodiments (FIGS. 2, 5, 7, 10, 13, 15, 17, 19, and 20) to communicate with an external apparatus through a communication network 200. In such a hardware configuration, the CPU 311 manages an entire operation of the information processing apparatus 300 providing the image recognition apparatus (10 to 16, 100, 103), the product DB management apparatus (30, 32), and the database management apparatus 105, according to the respective example embodiments.

For example, the respective aforementioned example embodiments are achieved by supplying a program (computer program) that is able to provide the processing described in the respective aforementioned example embodiments to the information processing apparatus 300 illustrated in FIG. 21, and reading the program to the CPU 311 to be executed. For example, such a program may be a program that is able to provide the various types of processing described in the respective aforementioned example embodiments, or the respective units (blocks) illustrated in the apparatuses in the block diagrams illustrated in FIGS. 2, 5, 7, 10, 13, 15, 17, 19, and 20.

Further, the program supplied into the information processing apparatus 300 may be stored in a readable-writable temporary storage memory (315) or a nonvolatile storage device (317) such as a hard disk drive. In other words, a program group 317A in the storage device 317 includes, for example, programs that are able to provide functions of the respective units illustrated in the image recognition apparatus (10 to 16, 100, 103), the product DB management apparatus (30, 32), and the database management apparatus 105, according to the respective aforementioned example embodiments. Further, various types of stored information 317B include, for example, a recognition result, a checking target DB, product data, a prior probability, and product quantity information, according to the respective aforementioned example embodiments. However, in implementation of the program on the information processing apparatus 300, a constituent unit of each program module is not limited to allocation of each block illustrated in the block diagrams (FIGS. 2, 5, 7, 10, 13, 15, 17, 19, and 20), and may be selected as appropriate by a person skilled in the art at implementation.

Further, in the case described above, a supply method of the program into the apparatus may employ a currently common procedure as described below:
a method of installation into the apparatus through various types of computer-readable recording media (319) such as a compact disc (CD)-ROM and a flash memory, or
a method of downloading through a communication line (200) such as the Internet.

In such a case, the respective example embodiments of the present invention may be viewed to be composed of a code (program group 317A) constituting such a computer program, or a storage medium (319) storing such a code.

Further, a function illustrated in each block illustrated in FIGS. 2, 5, 7, 10, 13, 15, 17, 19, and 20 may be provided in part or in whole as a hardware circuit.

The present invention has been described above as examples applied to the aforementioned exemplary example embodiments. However, the technical scope of the present invention is not limited to the respective aforementioned example embodiments. It is obvious to a person skilled in the art that various changes or modifications can be made to such example embodiments. In such a case, a new example embodiment with such a change or modification may be included in the technical scope of the present invention. This is obvious from matters described in CLAIMS.

The present application claims priority based on Japanese Patent Application No. 2015-052216 filed on Mar. 16, 2015, the disclosure of which is hereby incorporated by reference thereto in its entirety.

### REFERENCE SIGNS LIST

1 Image recognition system
2 Image recognition system
3 Image recognition system
10 Image recognition apparatus
11 Image recognition apparatus
12 Image recognition apparatus
13 Image recognition apparatus
14 Image recognition apparatus
15 Image recognition apparatus
16 Image recognition apparatus
20 Imaging device
21 POS terminal
30 Product DB management apparatus
31 Product DB
32 Product DB management apparatus
40 Network
50 POS system
100 Image recognition apparatus
101 Data determination unit
102 Image recognition unit
103 Image recognition apparatus
104 Image recognition unit
105 Database management apparatus
106 Data determination unit
110 Data processing unit
111 Data processing unit
120 Checking target data determination unit
122 Checking target data determination unit
1221 Determination unit
1222 Calculation unit
130 Image recognition unit
132 Image recognition unit
1321 Recognition unit
1322 Correction unit
136 Image recognition unit
140 Storage unit
141 Storage unit
150 Calculation unit
160 Correction unit
170 Reception unit
321 Data processing unit
322 Checking target data determination unit

1. A system comprising:
a data determination unit configured to specify checking target data being data of a checking target, from a database storing information about a plurality of products, based on product data related to a product sold at a store; and
an image recognition unit configured to recognize, by using an image captured at the store, a recognition target product included in the captured image, from the specified checking target data.

2. The system according to claim 1,
wherein the data determination unit specifies the checking target data, based on a quantity related to each product sold at the store.

3. The system according to claim 1,
wherein the data determination unit performs control in such a way that a recognition score indicating certainty of a recognition result with respect to a product a product inventory quantity of which is larger than that of another product is given a higher value than a recognition score with respect to the another product.

4. The system according to claim 3,
wherein the data determination unit includes a calculation unit configured to calculate, based on an inventory quantity of the product, a proportion of the product to a total number of products within a predetermined range,
wherein the image recognition unit includes a correction unit configured to correct a recognition result with respect to a recognition target product included in the captured image, based on the proportion calculated by the calculation unit,and
wherein the calculation unit calculates the proportion in such a way that the recognition score with respect to a product an inventory quantity of which is larger than that of another product is given a value higher than a recognition score with respect to the another product.

5. The system according to claim 4,
wherein, in at least either case of the recognition score with a highest value being less than a predetermined threshold value, or a difference between the recognition score with a highest value and a recognition score with a second highest value being less than a predetermined value, the correction unit corrects the recognition result, based on the proportion.

6. The system according to claim 1,
wherein the data determination unit specifies the checking target data by generating a database by deleting a product an inventory quantity of which in the store is zero, from the database, and
wherein the image recognition unit recognizes a product included in the captured image, by using a database generated by the data determination unit.

7. The system according to claim 1,
wherein the data determination unit updates the checking target data at a predetermined timing.

8. The system according to claim 2, further comprising
a data processing unit configured to receive the product data,
wherein the data processing unit calculates the quantity related to each product sold at the store, based on at least one of sales information, purchase information, and ordering information, being included in the product data.

9. The system according to claim 1,
wherein the captured image includes a position of a shelf in a captured store, and,
wherein, based on a position of the shelf, information indicating a product that may be displayed on the shelf, and the product data, the data determination unit specifies the checking target data to be a product that may be displayed on the shelf.

10. The system according to claim 1, further comprising
a storage unit configured to store information indicating the checking target data specified by the data determination unit.

11-13. (canceled)

14. A system comprising:
an image recognition unit configured to recognize, by using an image captured at a store, a recognition target product included in the captured image, from a database storing information about a plurality of products;
a calculation unit configured to calculate, based on product data related to a product sold at the store, a proportion of the product to a total number of products within a predetermined range; and
a correction unit configured to correct a recognition result with respect to a recognition target product included in the captured image, based on the proportion calculated by the calculation unit,
wherein the calculation unit calculates the proportion in such a way that a recognition score indicating certainty of the recognition result with respect to a product an inventory quantity of which is larger than that of another product is given a value higher than a recognition score with respect to the another product.

15. An image recognition method comprising:
based on product data related to a product sold at a store, specifying checking target data being data of a checking target, from a database storing information about a plurality of products; and,
by using an image captured at the store, recognizing a recognition target product included in the captured image, from the specified checking target data.

16. A computer-readable non-transitory recording medium storing a program causing a computer to perform:
data determination processing of specifying, based on product data related to a product sold at a store, checking target data being data of a checking target, from a database storing information about a plurality of products; and
image recognition processing of recognizing, by using an image captured at the store, a recognition target product included in the captured image, from the specified checking target data.

17. The image recognition method according to claim 15, comprising
specifying the checking target data, based on a quantity related to each product sold at the store.

18. The image recognition method according to claim 15, comprising
performing control in such a way that a recognition score indicating certainty of a recognition result with respect to a product a product inventory quantity of which is larger than that of another product is given a higher value than a recognition score with respect to the another product.

19. The image recognition method according to claim 18, comprising
calculating, based on an inventory quantity of the product, a proportion of the product to a total number of products within a predetermined range,
correcting a recognition result with respect to a recognition target product included in the captured image, based on the proportion, and
wherein the proportion is calculated in such a way that the recognition score with respect to a product an inventory quantity of which is larger than that of another product is given a value higher than a recognition score with respect to the another product.

20. The image recognition method according to claim 19,
wherein the recognition result is corrected, in at least either case of the recognition score with a highest value being less than a predetermined threshold value, or a difference between the recognition score with a highest value and a recognition score with a second highest value being less than a predetermined value, based on the proportion.

21. The image recognition method according to claim 15,
wherein the checking target data is specified by generating a database by deleting a product an inventory quantity of which in the store is zero, from the database, and
wherein the product included in the captured image is recognized by using the generated database .

22. The image recognition method according to claim 15, comprising
updating the checking target data at a predetermined timing.

23. The image recognition method according to claim 17, comprising
receiving the product data, and
calculating the quantity related to each product sold at the store, based on at least one of sales information, purchase information, and ordering information, being included in the product data.
